(19) United States
(12) Patent Application Publication
(10) Pub. No.: US 2024/0298172 A1
(43) Pub. Date: Sep. 5, 2024

(54) COMMUNICATION METHOD AND STATION

(71) Applicant: GUANGDONG OPPO MOBILE TELECOMMUNICATIONS CORP., LTD., Dongguan (CN)

(72) Inventors: Lei HUANG, Singapore (SG); Xinyi RAN, Dongguan (CN); Chaoming LUO, Dongguan (CN); Yang LIN, Dongguan (CN); Honghao JU, Dongguan (CN); Liuming LU, Dongguan (CN)

(21) Appl. No.: 18/658,633

(22) Filed: May 8, 2024

Related U.S. Application Data
(63) Continuation of application No. PCT/CN2021/130475, filed on Nov. 12, 2021.

(51) Int. Cl. H04W 12/02; H04W 12/033

(52) U.S. Cl. CPC H04W 12/02; H04W 12/033

(57) ABSTRACT

Provided is a communication method. The method includes: receiving, by a first station (STA), a block acknowledgement (BA) frame, wherein the BA frame carries first information and/or protected privacy-related information, the first information being configured to identify the protected privacy-related information.

### CROSS-REFERENCE TO RELATED APPLICATION

This application is a continuation of International Application No. PCT/CN2021/130475, filed Nov. 12, 2021, the entire disclosure of which is incorporated herein by reference.

### TECHNICAL FIELD

The present disclosure relates to the field of communications, and in particular, relates to a communication method and a station.

### BACKGROUND

In a related art, privacy-related information of a station (STA) is easily tracked by an illegal user, resulting in serious privacy breaches.

### SUMMARY

Embodiments of the present disclosure provide a communication method and a station.

A communication method is provided in some embodiments of the present disclosure. The method includes: receiving, by an STA, a BA frame, wherein the BA frame carries first information and/or protected privacy-related information, the first information being configured to identify the protected privacy-related information.

A communication method is further provided in some embodiments of the present disclosure. The method includes: transmitting, by a second STA, a BA frame, wherein the BA frame carries first information and/or protected privacy-related information, the first information being configured to identify the protected privacy-related information.

An STA is further provided in some embodiments of the present disclosure. The STA includes: a first receiver module, configured to receive a BA frame, wherein the BA frame carries first information and/or protected privacy-related information, the first information being configured to identify the protected privacy-related information.

An STA is further provided in some embodiments of the present disclosure. The STA includes: a first transmitter module, configured to transmit a BA frame, wherein the BA frame carries first information and/or protected privacy-related information, the first information being configured to identify the protected privacy-related information.

A station is provided in some embodiments of the present disclosure. The station includes a processor and a memory. The memory is configured to store a computer program, and the processor, when loading and running the computer program stored in the memory, is caused to enable the first station to perform the communication method as defined above.

A chip is provided in some embodiments of the present disclosure. The chip is configured to perform the communication method as defined above. The chip includes: a processor, wherein the processor, when loading and running a computer program from a memory, is caused to enable a device provided with the chip to perform the communication method as defined above.

A non-transitory computer-readable storage medium is provided in some embodiments of the present disclosure, wherein the non-transitory computer-readable storage medium is configured to store a computer program. The computer program, when loaded and run by a device, causes the device to perform the communication method as defined above.

A computer program product is provided in some embodiments of the present disclosure, wherein the computer program product includes one or more computer program instructions. The one or more computer program instructions, when loaded and run by a computer, cause the computer to perform the communication method as defined above.

A computer program is provided in some embodiments of the present disclosure. The computer program, when loaded and run by a computer, causes the computer to perform the communication method as defined above.

### BRIEF DESCRIPTION OF DRAWINGS

FIG. 1 is a schematic diagram of an application scenario according to some embodiments of the present disclosure.

FIG. 2 is a schematic diagram of a frame format of a multi-STA BA frame.

FIG. 3 is a flowchart of implementation of a communication method according to some embodiments of the present disclosure.

FIG. 4 is a flowchart of implementation of another communication method according to some embodiments of the present disclosure.

FIG. 5 is a flowchart of implementation of a BA frame protection mechanism according to some embodiments of the present disclosure.

FIG. 6 is a schematic structural diagram of an association request frame according to some embodiments of the present disclosure.

FIG. 7 is a schematic structural diagram of another association request frame according to some embodiments of the present disclosure.

FIG. 8 is a schematic structural diagram of another association request frame according to some embodiments of the present disclosure.

FIG. 9 is a schematic diagram of a frame format of a protected multi-STA BA frame according to the present disclosure.

FIG. 10 is a schematic diagram of another frame format of a protected multi-STA BA frame according to the present disclosure.

FIG. 11 is a schematic diagram of a frame format of a protected multi-STA BA frame according to the present disclosure.

FIG. 12 is a schematic diagram of another frame format of a protected multi-STA BA frame according to the present disclosure.

FIG. 13 is a schematic diagram of another frame format of a protected multi-STA BA frame according to the present disclosure.

FIG. 14 is a schematic diagram of implementation of encryption and decryption of a multi-STA BA frame according to the present disclosure.

FIG. 15 is a flowchart of implementation of another communication method according to some embodiments of the present disclosure.

FIG. 16 is a schematic structural diagram of an STA according to some embodiments of the present disclosure.

FIG. 17 is a schematic structural diagram of another STA according to some embodiments of the present disclosure.

FIG. 18 is a schematic structural diagram of a communication device 1800 according to some embodiments of the present disclosure.

FIG. 19 is a schematic structural diagram of a chip 1900 according to some embodiments of the present disclosure.

### DETAILED DESCRIPTION

Technical solutions in the embodiments of the present disclosure will be described below with reference to the accompanying drawings in the embodiments of the present disclosure.

It should be noted that terms “first,” “second,” and the like in the specification and claims of the embodiments of the present disclosure and the above accompanying drawings are configured to distinguish similar objects, and do not have to be taken to describe a specific order or sequence. For the terms “first” and “second” that are described at the same time, the objects described may be the same or different.

The technical solutions of the embodiments of the present disclosure are applicable to various communication systems, such as a wireless local area network (WLAN) system, a wireless fidelity (Wi-Fi) network system, or other communication systems.

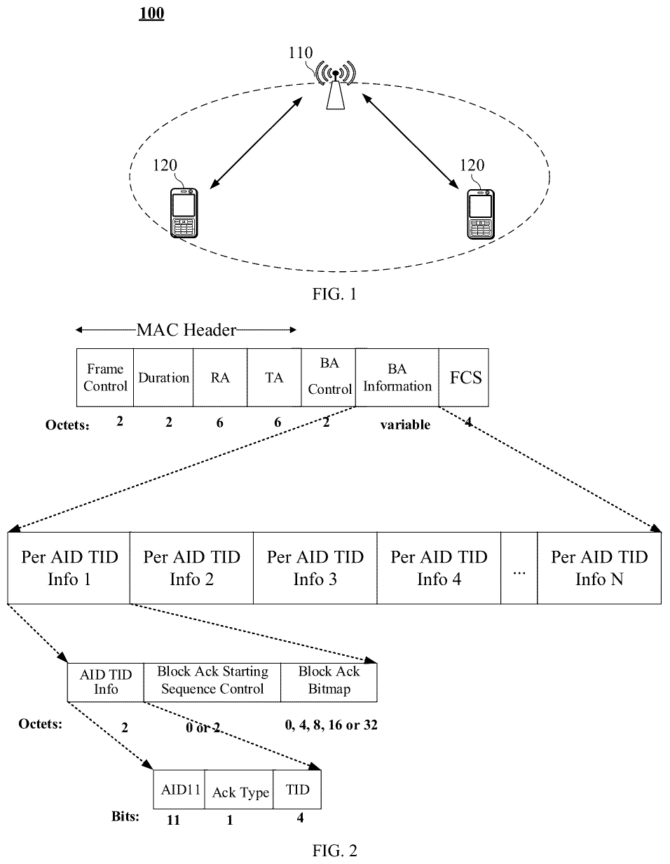

For example, a communication system 100 to which the embodiments of the present disclosure are applicable is shown in FIG. 1. The communication system 100 includes an access point (AP) 110 and STAs 120 connected to a network over the access point 110.

In some scenarios, an AP is also referred to as an AP STA. That is, in a sense, an AP is also an STA.

In some scenarios, an STA is also referred to as a non-AP STA.

Communication in the communication system 100 is communication between an AP and a non-AP STA, communication between a non-AP STA and a non-AP STA, or communication between an STA and a peer STA. The peer STA refers to a device in communication with an STA at an opposite side. For example, the peer STA may be an AP or a non-AP STA.

The AP acts as a bridge between wired and wireless networks, and mainly functions to connect devices or clients under the wireless network together and then connect the wireless network to the wired network, i.e., Ethernet. The AP device is a terminal device (e.g., a mobile phone) equipped with a Wi-Fi chip or a network device (e.g., a router).

It is understandable that an STA in the communication system plays diversified roles in the communication system. For example, in some scenarios, in the case that a mobile phone is connected to a router, the mobile phone acts as a non-AP STA, and in the case that a mobile phone provides a hotspot for other mobile phones, the mobile phone acts as an AP.

The AP and the non-AP STA may be devices applicable to the Internet of vehicles, nodes and sensors and the like in the Internet of things (IoT), smart cameras, smart remote controllers, smart water meters, smart electric meters and the like in smart homes, and sensors and the like in smart cities.

In some embodiments, the non-AP STA supports the 802.11be standard. The non-AP STA further supports a plurality of current and future 802.11 WLAN standards, such as 802.11ax, 802.11ac, 802.11n, 802.11g, 802.11b, and 802.11a.

In some embodiments, the AP is a device that supports the 802.11be standard. The AP is further a device that supports a plurality of current and future 802.11 WLAN standards, such as 802.11ax, 802.11ac, 802.11n, 802.11g, 802.11b, and 802.11a.

In the embodiments of the present disclosure, the STA is a mobile phone, a pad, a computer, a virtual reality (VR) device, an augmented reality (AR) device, a wireless device in industrial control, a set-top box, a wireless device in self-driving, a vehicle-mounted communication device, a wireless device in a remote medical system, a wireless device in smart grids, a wireless device in transportation safety, a wireless device in smart cities or a wireless device in smart homes, or a wireless communication chip/ASIC/SOC/and the like that supports WLAN/Wi-Fi technologies.

The WLAN technology-supportable frequency bands include, but are not limited to: low-frequency bands (e.g., 2.4 GHz, 5 GHz, and 6 GHz) and high-frequency bands (e.g., 60 GHz).

For example, FIG. 1 shows one AP STA and two non-AP STAs. In some embodiments, the communication system 100 includes a plurality of AP STAs and includes other numbers of non-AP STAs, which are not limited in the embodiments of the present disclosure.

It is understandable that terms “system” and “network” are often used interchangeably herein. A term “and/or” used herein is merely an association relationship describing associated objects, and refers to that there may be three relationships. For example, A and/or B, may mean that A is present alone, A and B are present simultaneously, and B is present alone. In addition, the symbol “/” used herein generally indicates an “or” relationship between the associated objects.

It is understandable that “indication” mentioned in the embodiments of the present disclosure may be a direct indication, an indirect indication or an indication that there is an association relationship. For example, A indicates B, which may mean that A indicates B directly, for example, B is acquired by A; or that A indicates B indirectly, for example, A indicates C, wherein B is acquired by C; or that an association relationship is present between A and B.

In the description of the embodiments of the present disclosure, a term “corresponding” may refer to a direct corresponding relationship or an indirect corresponding relationship that is present between two items, may refer to an association relationship that is present between two items, or may refer to another relationship such as indicating and being indicated, and configuring and being configured.

For convenience of understanding the technical solutions of the embodiments of the present disclosure, the following description is provided for related technologies of the embodiments of the present disclosure, and the following related technologies, as alternatives, may be arbitrarily combined with the technical solutions of the embodiments of the present disclosure, all of which fall within protection scope of the embodiments of the present disclosure.

The STA is a station in a wireless network, and one STA may serve as a central node of the wireless network, i.e., an AP, or may serve as a node connected to the wireless network, i.e., a non-AP STA. Hereinafter, an STA as a non-AP STA is simply referred to as an STA, and an STA as an AP is simply referred to as an AP. The privacy-related information according to the present disclosure includes identity identifier information of the STA, such as an AID of the STA. The following description is provided for the related technologies of the present disclosure by using AID as an example.

In a phase of associating an STA with an AP, the STA acquires its own AID from the AP. In the case that the AP subsequently transmits a control frame (e.g., a BA frame) to the STA, the control frame carries information that needs to be sent to the STA, wherein the information carries an AID of the STA. In this way, in the case that the STA receives the control frame and identifies that the AID in the information is the same as or corresponds to its own AID, the STA determines that the information is transmitted by the AP to the STA, and then the STA extracts the information and performs subsequent processing.

Using a multi-STA BA frame as an example, FIG. 2 is a schematic diagram of a frame format of a multi-STA BA frame, wherein the multi-STA BA frame includes a MAC header, a BA control field, a BA information field and a frame check sequence (FCS). The BA information field includes one or more information (Per AID TID Info) fields identified by association identifiers (AIDs) and traffic identifiers (TIDs) tuples, and each per association identifier traffic identifier information (Per AID TID Info) field corresponds to one <AID, TID> tuple. The Per AID TID Info field includes an AID TID information (AID TID Info) field, a block acknowledgement starting sequence control (Block Ack Starting Sequence Control) field, and a block acknowledgement bitmap (Block Ack Bitmap) field, wherein the AID TID Info field further includes an AID11 field, the AID11 field being 11 bits in length and being configured to carry an AID of an STA. Currently-available reserved values of the AID are 2008-2044 and 2047, and FIG. 2 shows a frame format of a multi-STA BA frame with AID11≠2045 (as AID=2045 has special use, its frame format field is not considered).

As can be seen from the frame format shown in FIG. 2, a multi-STA BA frame sent by an AP may include information that needs to be sent to a plurality of STAs, wherein information of different STA is carried in different Per AID TID Info field, and the Per AID TID Info fields carries an AID of different STA and identifies which STA the Per AID TID Info field corresponds to. Upon receiving the multi-STA BA frame, the STA compares its own AID with an AID carried in each of the Per AID TID Info fields, the STA determines that information (e.g., an acknowledgement type (Ack type), a TID and a block Ack bitmap) in the Per AID TID Info field is assigned to the STA in the case that the AID is consistent with an AID in one Per AID TID Info field, and then extracts the information and performs subsequent processing.

As can be seen from the above description, a frame body of the control frame such as the multi-STA BA frame is not encrypted, an identity identifier information (the identity identifier information belongs to privacy-related information) such as the AID of the STA is easily tracked by an illegal user, such that a mapping relationship between an AID of a user and an MAC address is easily revealed, and whether the user is in the current region may also be disclosed, and in addition, parameter information in the frame may also disclose information such as traffic consumption of an ongoing service of the user, thereby greatly threatening the privacy security of the user. Therefore, for a control frame carrying identity identifier information such as an unencrypted AID and related parameter information, a serious privacy exposure problem is caused, such as effective tracking of a user through a mapping relationship between the AID and the MAC address.

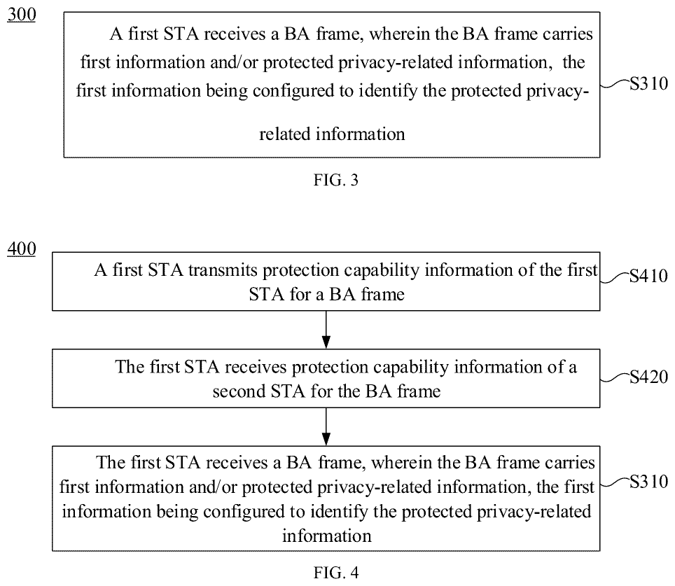

In view of the above problem, a communication method is provided in the present disclosure, and in some embodiments, the method is applicable to the system shown in FIG. 1, but is not limited thereto. FIG. 3 is a flowchart of implementation of a communication method according to some embodiments of the present disclosure. The method includes at least some of the following process.

In S310, a first STA receives a BA frame, wherein the BA frame carries first information and/or protected privacy-related information, the first information being configured to identify the protected privacy-related information.

In some embodiments, the BA frame includes a multi-STA BA frame.

In some embodiments, the privacy-related information includes an AID.

For example, a first STA may receive a multi-STA BA frame from a second STA (e.g., an AP), wherein the multi-STA BA frame carries information for a plurality of STAs, the information for different STAs including protected AIDs of corresponding STAs and first information. For example, the protected AID includes a ciphertext acquired by encrypting the AID, digest information acquired by computing the AID using an information digest algorithm, a ciphertext acquired by encrypting the AID and other information, and/or digest information acquired by computing the AID and other information using an information digest algorithm; and the first information includes encryption and/or information digest algorithm and other contents utilized to perform the aforementioned processing on the AID, thereby enabling the first STA to identify the protected AID. In the case that the first STA identifies that a protected AID is consistent with its own AID, the first STA determines that part of content of the multi-STA BA frame including the protected AID is sent to itself, and then the first STA extracts the part of the content and performs subsequent processing.

Before the first STA receives the BA frame, the first STA and the second STA may announce their protection capabilities for the BA frame, and as shown in FIG. 4, a flowchart of implementation of another communication method according to some embodiments of the present disclosure is shown. Prior to the process S310, the method further includes the following processes.

In S410, the first STA transmits protection capability information of the first STA for the BA frame.

In S420, the first STA receives protection capability information of a second STA for the BA frame.

The processes S410 and S420 do not require an execution order, and any process may be performed first or the two processes may be performed in synchronization.

The first STA may be a non-AP STA and the second STA may be an AP. Using a wireless network including a plurality of non-AP STAs (STAs for short) as an example, each of the STAs transmits protection capability information thereof for a BA frame to an AP, for example, the STA announces that it has the capability of identifying a protected AID; and the AP transmits protection capability information thereof for the BA frame to each of the STAs, for example, the AP announces that it has the capability of protecting the AID (for example, the AP supports encrypting the AID and/or processing the AID by using an information digest algorithm).

In addition, prior to the process S310, the first STA generates a key by performing key agreement with the second STA. The key may be configured for encrypting and decrypting an AID, computing digest information, and the like. The process of performing key agreement and the processes S410 and S420 do not require an execution order, and it is only necessary to complete the key agreement prior to the process S310.

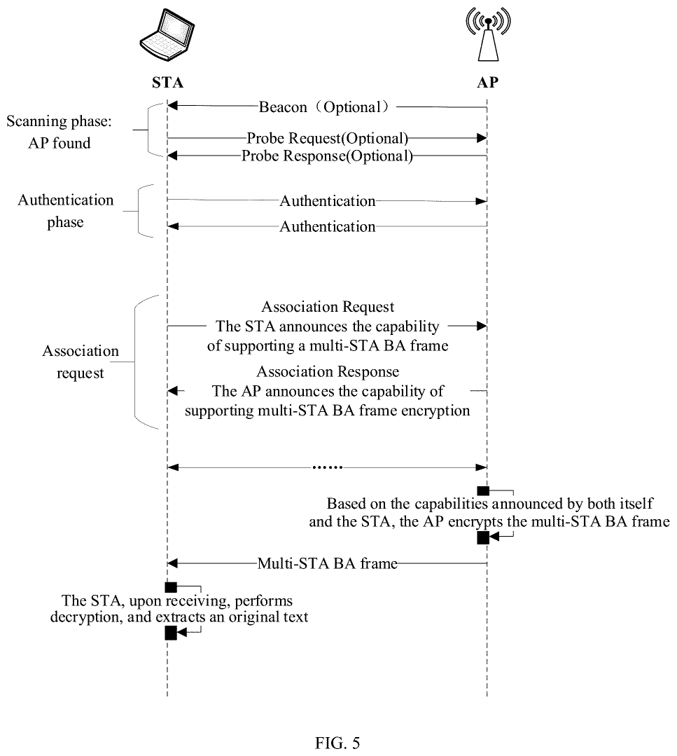

FIG. 5 is a flowchart of implementation of a BA frame protection mechanism according to some embodiments of the present disclosure, and description is given in FIG. 5 by using the first STA being an STA, the second STA being an AP, and the BA frame being a multi-STA BA frame. The implementation of the BA frame protection mechanism includes the following processes.

(1) Scanning phase and authentication phase: these two phases are consistent with the conventional IEEE 802.11 procedure. The procedure includes that: an AP transmits a beacon frame to an STA, the STA transmits a probe request frame to the AP, and the AP returns a probe response frame to the STA, wherein the three processes are optional processes and are configured to enable the STA to discover the AP in a wireless network. The procedure further includes that: the STA and the AP transmit an authentication frame to each other for completing authentication.

(2) Association phase: in the association phase, the STA and the AP may announce their protection capabilities for a BA frame. In the example shown in FIG. 5, the STA, when transmitting an association request, announces its capability of supporting the multi-STA BA frame protection mechanism to the AP; and then the AP, when transmitting an association response, announces its capability of supporting the multi-STA BA frame protection mechanism to the STA.

(3) After association, in the case that the AP needs to transmit a multi-STA BA frame to the STA in the wireless network, the AP protects the multi-STA BA frame based on its own capability and the capability announced by the STA. For example, the AP encrypts an AID in the multi-STA BA frame or generate a digest of the AID (for example, the AP generates a digest of the AID by using a Hash algorithm). The STA, upon receiving the protected multi-STA BA frame, identifies whether the protected AID transmitted by the AP is consistent with its own AID by using a key, and determines that part of content of the multi-STA BA frame including the protected AID is transmitted to the STA in the case that the AIDs are consistent. In this case, the STA extracts the part of the content and performs subsequent processing.

As the multi-STA BA frame may include information transmitted by the AP to a plurality of STAs, the information corresponding to different STAs may carry the protected AID of the STA. The STA, upon receiving the multi-STA BA frame, compares whether its own AID is consistent with each of the protected AIDs in the multi-STA BA frame. In the case that a protected AID consistent with the AID is found, the STA determines that part of information in the multi-STA BA frame carrying the protected AID belongs to the STA, and then extracts and processes this part of information; and in the case that the protected AIDs are inconsistent with the AID of the STA, part of information including these protected AIDs does not belong to the STA (possibly the AP needs to transmit this part of information to other STAs), such that the STA does not process this part of information.

In addition, in a wireless network, a part of STAs may have the capability of supporting a BA frame protection mechanism, and another part of STAs may not have the capability of supporting the BA frame protection mechanism (hereinafter, referred to as the protection capability for a BA frame). In this case, when transmitting a multi-STA BA frame, the AP may protect an AID of an STA having the capability of protecting a BA frame and carry a protected AID of the STA in the multi-STA BA frame, and may not protect an AID of an STA without the capability of protecting a BA frame and carry the AID of the STA in the multi-STA BA frame.

It should be noted that the present disclosure does not limit the type of protection technology (including encryption and/or digest), and only requires that the corresponding key exchange should be done before the multi-STA BA frame is transmitted. Symmetric encryption algorithms and/or asymmetric encryption algorithms, such as the advanced encryption standard (AES) 128 algorithm, the AES192 algorithm, the AES256 algorithm, the elliptic curves cryptography (ECC) p256 algorithm, and the ECC p384 algorithm, may be used. Message digest algorithms, such as the Hash algorithm, the Hash-based message authentication code (HMAC) algorithm, the cipher-block chaining-MAC (CBC-MAC) algorithm and the Galois message authentication code mode (GMAC) algorithm, may also be used. Unlike the encryption-only method, the STA receiving the multi-STA BA frame needs to compute the information known by the STA (e.g., the AID or other information of the STA) by using the same algorithm, and compares generated digest information with each of the received protected AIDs. In the case that the generated digest information is consistent with the received protected AID, related information indicated by the protected AID is for the STA. In the case that the generated digest information is not consistent with the received protected AID, the related information is ignored. The present disclosure may protect the AIDs by using the aforementioned encryption algorithms or the message encryption algorithms, or protect the AIDs by using the encryption algorithms and the message digest algorithms. For example, the AP generates a ciphertext of the AID by encrypting an AID by using an encryption algorithm, and then generates digest information by computing the AID and other information (or the ciphertext of the AID and other information) by using a message digest algorithm; and the AP carries the ciphertext of the AID, the digest information and the other information in a multi-STA BA frame and transmits the multi-STA BA frame. The STA, upon receiving the multi-STA BA frame, acquires a plaintext of the AID by decrypting the ciphertext of the AID, and determines whether the plaintext of the AID is consistent with its own AID; generates digest information by computing the same data (i.e., the AID and other information, or the ciphertext of the AID and other information) using the same message digest algorithm, and determines whether the digest information is consistent with a received digest information. The STA identifies that the information indicated by the AID belongs to the AID in the case that the plaintext of the AID is consistent with the AID of the STA and the digest information is consistent with the received digest information. As the message digest algorithm prevents the message from being tampered, compared with protecting the AID by using an encryption algorithm, protecting the AID by using a message digest algorithm or protecting the AID by using both of an encryption algorithm and a message digest algorithm avoids an error in identification of the AID by the STA and an attack of an attacker in a network.

The communication method for achieving multi-STA BA frame protection according to the present disclosure will be described in detail hereinafter with reference to the accompanying drawings.

As mentioned above, the STA and the AP may announce their own capabilities of supporting the multi-STA BA frame protection mechanism by means of the association request frame and the association response frame, respectively, at the association phase. In some embodiments, before the first STA receives the BA frame, the method further includes: transmitting, by the first STA, protection capability information of the first STA for the BA frame. The first STA is a non-AP STA (hereinafter referred to as an STA). The first STA transmits the protection capability information of the first STA for the BA frame to a second STA (e.g., an AP). For example, the protection capability information of the first STA for the BA frame is carried in an association request frame and/or an authentication frame transmitted by the first STA.

The protection capability information of the first STA for the BA frame is carried in the association request frame or the authentication frame in the following manners:

### Manner 1:

A new field is added in the association request frame and/or the authentication frame, wherein the new field is configured to carry the protection capability information of the first STA for the BA frame. For example, the association request frame and/or the authentication frame includes a first protection capability information field, wherein the first protection capability information field includes a first field indicating protection capability of the BA frame, wherein the first field indicating protection capability of the BA frame carries the protection capability information of the first STA for the BA frame.

Further, the newly-added first protection capability information field further includes at least one of a first field indicating protection capability of a trigger frame or a first field indicating protection capability of a null data packet announcement (NDPA); wherein the first field indicating protection capability of the trigger frame carries protection capability information of the first STA for the trigger frame; and the first field indicating protection capability of the NDPA carries protection capability information of the first STA for the NDPA.

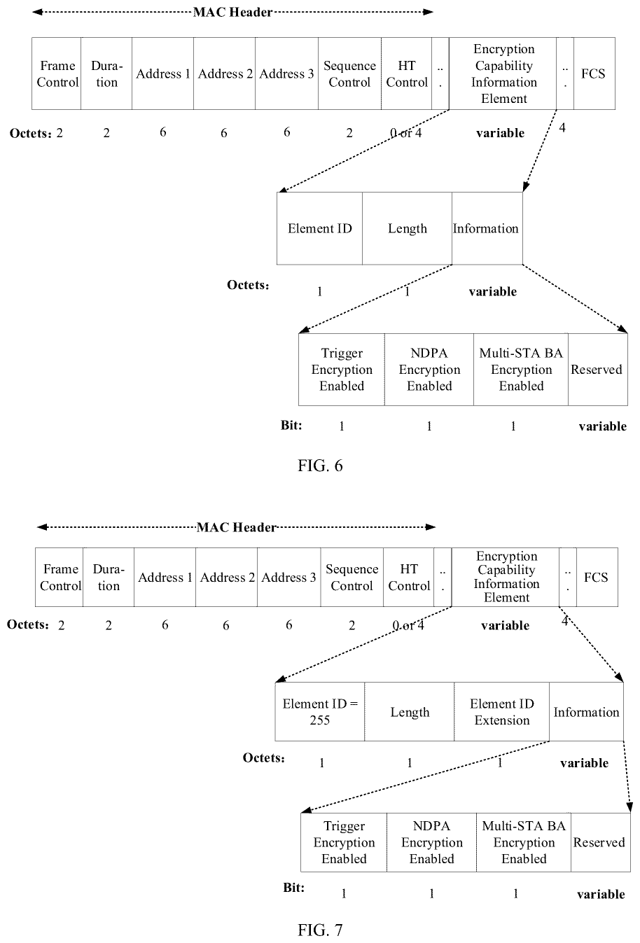

Using the association request frame carrying the protection capability information of the first STA for the BA frame as an example, FIG. 6 is a schematic structural diagram of an association request frame according to some embodiments of the present disclosure, and as shown in FIG. 6, the association request frame includes: a MAC header, a newly-added encryption capability information element field and an FCS field. The MAC header includes a frame control field (2 bytes in length), a duration field (2 bytes in length), an address 1 field (6 bytes in length), an address 2 field (6 bytes in length), an address 3 field (6 bytes in length), a sequence control field, and an HT control field (0 or 4 bytes in length). The length of the newly-added encryption capability information element field is variable, with the protection capability information of the first STA for the BA frame carried therein. In the example of FIG. 6, the protection capability primarily refers to the encryption capability, and a related protection capability field is also referred to as an encryption capability field; and a specific protection method is not limited in the present disclosure, which may include encryption and/or generation of digest information by using an information digest algorithm.

The newly-added first protection capability information field further includes a first element identifier field, wherein the first element identifier field carries a specified element identification value, the value belonging to a reserved value in the current element identification value and being configured to identify the first protection capability information field. The reserved value may refer to a reserved value in an issued standard, and the reserved value belongs to a value that is not processed for devices that conforming to the issued standard. Using the association request frame shown in FIG. 6 as an example, the newly-added encryption capability information element field includes an element identification (element ID) field (1 byte in length), a length field (1 byte in length) and an information field (with a variable length). The element ID field carries an element identification value belonging to a reserved value, such as any value of 2, 4, 8, 9, 17-31, 47, 49, 77, 103, 128-129, 133-136, 149-150, 155-156, 165, 173, 176, 178-180, 203, 218-219, 227, 238, 243, and 245-254, wherein the element identification value is configured to identify that the field to which the element ID field belongs is the newly-added encryption capability information element field.

As shown in FIG. 6, an information field of the encryption capability information element field includes a multi-STA BA encryption enabled field (1 bit in length), wherein the multi-STA BA encryption enabled field is configured to carry protection capability information of the first STA for the multi-STA BA frame. The information field may further include a trigger encryption enabled field and/or an NDPA encryption enabled field, wherein the trigger encryption enabled field and/or the NDPA encryption enabled field is configured to carry protection capability information of the first STA for the trigger frame and protection capability information of the first STA for the NDPA. It should be noted that the information field shown in FIG. 6 includes the aforementioned three capability fields, which are not limited in the present disclosure, and the information field may include one or more of the aforementioned three capability fields to carry the corresponding protection capability information.

### Manner 2:

A new field is added in the association request frame and/or the authentication frame, wherein the new field is configured to carry the protection capability information of the first STA for the BA frame. For example, the association request frame and/or the authentication frame includes a first protection capability information field, wherein the first protection capability information field includes a first field indicating protection capability of the BA frame, wherein the first field indicating protection capability of the BA frame carries the protection capability information of the first STA for the BA frame.

Further, the newly-added first protection capability information field further includes at least one of a first field indicating protection capability of a trigger frame or a first field indicating protection capability of a null data packet announcement (NDPA); wherein the first field indicating protection capability of the trigger frame carries protection capability information of the first STA for the trigger frame; and the first field indicating protection capability of the NDPA carries protection capability information of the first STA for the NDPA.

Using the association request frame carrying the protection capability information of the first STA for the BA frame as an example, FIG. 7 is a schematic structural diagram of another association request frame according to some embodiments of the present disclosure, and as shown in FIG. 7, the association request frame includes: a MAC header, a newly-added encryption capability information element field and an FCS field. The MAC header includes a frame control field (2 bytes in length), a duration field (2 bytes in length), an address 1 field (6 bytes in length), an address 2 field (6 bytes in length), an address 3 field (6 bytes in length), a sequence control field and an HT control field (0 or 4 bytes in length). The length of the newly-added encryption capability information element field is variable, with the protection capability information of the first STA for the BA frame carried therein. In the example of FIG. 7, the protection capability primarily refers to the encryption capability, and the related protection capability field is also referred to as an encryption capability field; and the specific protection method is not limited in the present disclosure, which may include encryption and/or generation of digest information by using an information digest algorithm.

For example, the newly-added first protection capability information field further includes a second element identifier field and a first element identification extension field.

In some embodiments, a value of the second element identifier field is 255; and the first element identification extension field carries a first element extension identification value, wherein the first element extension identification value is configured to identify a first protection capability information field; and the first element extension identification value is an element extension identification value that currently belongs to the reserved value. Using the association request frame shown in FIG. 7 as an example, the newly-added encryption capability information element field includes an element identification (element ID) field (1 byte in length), a length field (1 byte in length), an element identification extension (element ID extension) field (1 byte in length) and an information field (with a variable length). A value of the element ID field is 255, and the element ID extension field carries an element extension identification value belonging to a reserved value, such as any value of 0, 32, 35-39, 41-43, 45-51, 55, 57-87, and 94-255, wherein the element extension identification value is configured to identify that the field to which the element ID field and the element ID extension field belong is the newly-added encryption capability information element field.

The information field in the encryption capability information element field in FIG. 7 is the same as the information field in FIG. 6, which is not repeated herein.

### Manner 3:

A new field is added in an existing extended capability element in the association request frame and/or the authentication frame, wherein the new field is configured to carry protection capability information of the first STA for the BA frame. For example, the association request frame and/or the association authentication frame includes a first extended capability field, wherein the first extended capability field includes a second field indicating protection capability of a BA frame, wherein the second field indicating protection capability of the BA frame carries the protection capability information of the first STA for the BA frame.

Further, another field is added in the existing extended capability element, wherein the field is configured to carry a protection capability of the first STA for the trigger frame and/or a protection capability of the first STA for the NDPA. For example, the first extended capability field further includes at least one of a second field indicating protection capability of a trigger frame or a second field indicating protection capability of a NDPA; wherein the second field indicating protection capability of the trigger frame carries protection capability information of the first STA for the trigger frame; and the second field indicating protection capability of the NDPA carries protection capability information of the first STA for the NDPA.

In some embodiments, the second field indicating protection capability of the BA frame, the second field indicating protection capability of the trigger frame or the second field indicating protection capability of the NDPA occupies a first position of the first extended capability field.

In some embodiments, the first extended capability field further includes a third element identifier field, wherein the third element identifier field is configured to identify the first extended capability field.

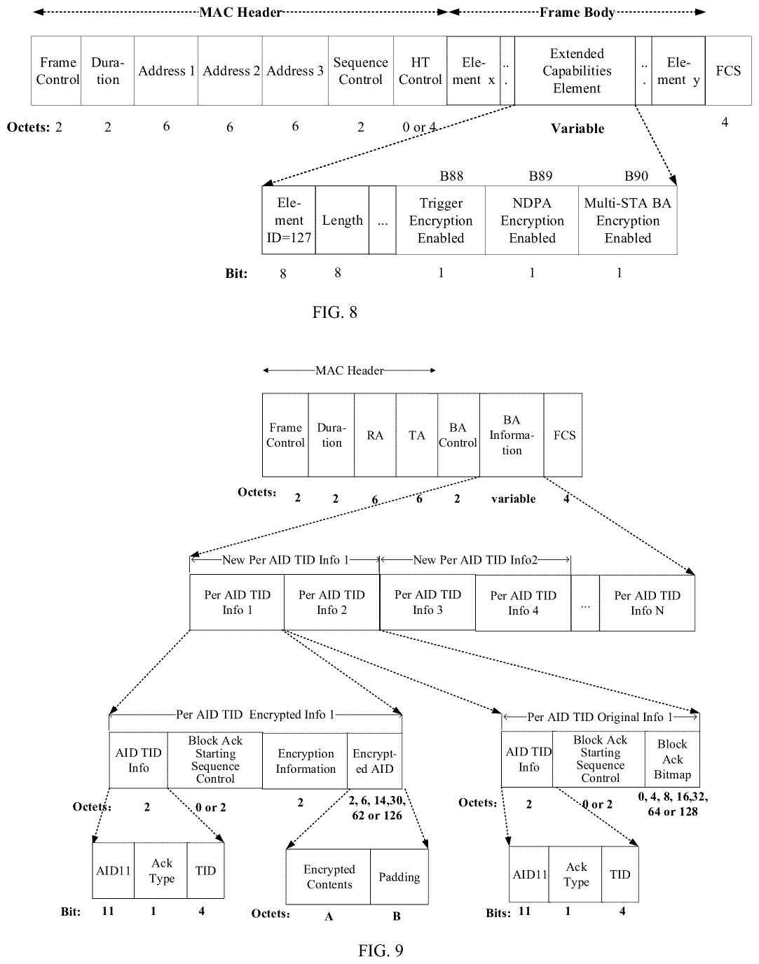

Using the association request frame carrying the protection capability information of the first STA for the BA frame as an example, FIG. 8 is a schematic structural diagram of another association request frame according to some embodiments of the present disclosure, and as shown in FIG. 8, the association request frame includes: a MAC header, an extended capability element field, an element x, an element y, and the like. The extended capability element has a variable length, carries the protection capability information of the first STA for the BA frame, and may further carry the protection capability information of the first STA for the trigger frame and/or the protection capability information of the first STA for the NDPA. In the example of FIG. 8, the protection capability primarily refers to the encryption capability, and the related protection capability field is also referred to as an encryption capability field; and the specific protection method is not limited in the present disclosure, which may include encryption and/or generation of digest information by using an information digest algorithm. In some embodiments, a value of a third element identifier field (e.g., the element ID field in FIG. 8) in the extended capability element is 127, and a multi-STA BA encryption enabled field, a trigger encryption enabled field and an NDPA encryption enabled field are configured to carry protection capability information of the first STA for a BA frame, protection capability information of the first STA for a trigger frame and protection capability information of the first STA for an NDPA, respectively; and these three fields may occupy any first position, such as B5, B35, B59, B76-B79, B83, B86, B88-Bn or a new bit, wherein the first position may refer to a reserved bit in the issued standard. In FIG. 8, B88, B89 and B90 are taken as examples. It should be noted that the extended capability element field shown in FIG. 8 includes the aforementioned three encryption enabled fields, which are not limited in the present disclosure. The extended capability element field may include one or more of the aforementioned three encryption enabled fields to carry the corresponding encryption capability information.

The above description is provided for an implementation manner in which the association request frame and/or the authentication frame transmitted by the first STA (e.g., the STA) carries the protection capability information of the STA for the BA frame. The present disclosure may further use an association response frame or an authentication frame to carry protection capability information of a second STA (e.g., an AP) for the BA frame. A specific frame structure may refer to the frame structures proposed in the three methods mentioned above, that is, the association request frame in the three methods is replaced with an association response frame to carry the protection capability information of the AP; and the specific frame structure is the same as the frame structures shown in FIG. 6 to FIG. 8, and is not repeated herein.

After the STA and the AP perform capability announcement and perform key agreement, the AP may transmit a BA frame carrying first information and protected privacy-related information to the STA, wherein the first information is configured to identify the protected privacy-related information.

In some embodiments, the BA frame includes a BA information field; wherein the BA information field includes at least one first protection field; the first protection field including a first Per AID TID Info field; and the first Per AID TID Info field carrying the first information and the protected privacy-related information.

The first information includes at least one of: encryption algorithm information and/or message digest algorithm information; a length of the protected privacy-related information; or first indication information, wherein the first indication information is configured to indicate whether the first protection field includes a second Per AID TID Info field.

The second Per AID TID Info field carries at least one of a block Ack bitmap (BA bitmap), an acknowledgement type (Ack type), or a TID. The second Per AID TID Info field may refer to a Per AID TID Info field included in a BA information field of an original multi-STA BA frame.

In the case that the AP protects the BA frame, compatibility of the BA frame with a legacy station (Legacy-STA), i.e., a device conforming to the issued standard needs to be considered. The present disclosure mainly modifies a body part of the BA frame. Using the multi-STA BA frame as an example, a specific frame format design of the present disclosure after the protection of the multi-STA BA frame is shown in FIG. 9, where the protected multi-STA BA frame includes a MAC header, a BA control field, a duration field, an RA field, a TA field, a BA information field, an FCS field, and the like. The BA information field includes one or more first protection fields, such as a new Per AID TID Info field in FIG. 9. The new Per AID TID Info field consists of a first Per AID TID Info field and a second Per AID TID Info field. For example, the first Per AID TID Info field is a Per AID TID Encrypted Info field in FIG. 9, and the second Per AID TID Info field is a Per AID TID Original Info field in FIG. 9. The Per AID TID Encrypted Info field is configured to carry a protected AID, and the Per AID TID Original Info field is configured to carry block Ack staring sequence control and block Ack bitmap information in the original Per AID TID field. One specific design of the positions of the Per AID TID Encrypted Info field and the Per AID TID Original Info field in the frame and the frame format is shown in FIG. 9.

In some embodiments, the first Per AID TID Info field includes a protection information field and a protected AID field; wherein

the protection information field carries the encryption algorithm information and/or the message digest algorithm information; and

the protected AID field carries the protected privacy-related information.

Further, the first Per AID TID Info field may include a block acknowledgement starting sequence control field, wherein the block acknowledgement starting sequence control field is configured to indicate a sum of the length of the protection information field and the length of the protected AID field.

In some embodiments, an information protection field included in the first Per AID TID Info field is included in the first AID TID information field of the first Per AID TID Info field, and in this case, a block acknowledgement starting sequence control field included in the first Per AID TID Info field is configured to indicate a length of the protected AID field.

In some embodiments, to identify the first Per AID TID Info field and the second Per AID TID Info field, the first Per AID TID Info field in the present disclosure carries a first AID value, wherein the first AID value is configured to identify the first Per AID TID Info field. The first AID value belongs to a reserved AID value in the issued standard, and the reserved AID value belongs to a value that is not processed for devices that conforming to the issued standard. The second Per AID TID Info field in the present disclosure carries a second AID value, wherein the second AID value is configured to identify the second Per AID TID Info field. The second AID value belongs to a reserved AID value in the issued standard, and the reserved AID value belongs to a value that is not processed for devices that conforming to the issued standard. The second AID value may be the same as or different from the first AID value.

Using the frame format shown in FIG. 9 as an example, the first Per AID TID Info field (i.e., an AID11 field in the Per AID TID Encrypted Info field) in the first Per AID TID Info field (i.e., the Per AID TID Encrypted Info field in FIG. 9) carries a first AID value, such as 2038, 2039, or 2047, or any value of 2008-2044, wherein the first AID value is configured to indicate that the Per AID TID Info field is the Per AID TID Encrypted Info field. The Per AID TID Encrypted Info field includes an AID TID Info field, a block Ack starting sequence control field, an encryption information field and an encrypted AID field. It can be seen that the encryption information field and the encrypted AID field occupy a position of the block Ack bitmap field in the original Per AID TID Info field, such that the block Ack starting sequence control field indicates a sum of the length of the encryption information field and the length of the encrypted AID field. Using encryption protection of an AID as an example, the encryption information field carries an encryption method, and/or an encryption length, and/or an Origin BA Info indication; wherein the Origin BA Info indication is configured to indicate whether a Per AID TID Original Info field is included behind the Per AID TID Encrypted Info field. The encrypted AID field includes an encrypted contents field, wherein the encrypted contents field is configured to carry a ciphertext upon encrypting the AID, and the encrypted AID field further includes a padding field.

Upon reading an AID TID Info field in the Per AID TID Info field, an STA with the capability of protecting a BA frame finds that the AID TID Info field carries the first AID value, and determines that the Per AID TID Info field is the Per AID TID Encrypted Info field; and then, the STA determines whether a protected AID carried in the Per AID TID Encrypted Info field is consistent with its own AID.

Upon reading an AID TID Info field in the Per AID TID Info field, a Legacy-STA without the capability of protecting a BA frame finds that the first AID value carried in the AID TID Info field cannot correspond to a valid AID within a range of 1-2007, which indicates that the Per AID TID Info field is information that the Legacy-STA has no capability to process, and the Legacy-STA ignores subsequent corresponding information (i.e., information in the encryption information field and the encrypted AID field) based on the length indicated in the block Ack starting sequence control field.

For the sum of the length of the encryption information field and the length of the encrypted AID field, an appropriate length (the length is indicated in the block Ack starting sequence control field) is selected based on an output length requirement of an encryption algorithm, and the sum of the length of the encryption information field and the length of the encrypted AID field may be 4, 8, 16, 32, 64, or 128 bytes. For example, the encryption information field is 2 bytes in length, and the encrypted AID field may be 2, 6, 14, 30, 62, or 126 bytes in length. In the case that the AES128 encryption algorithm is utilized, a ciphertext length is an integer multiple of 128 bits (i.e., 16 bytes), a minimum length of the encrypted contents field carrying the ciphertext (i.e., A in FIG. 9) is 16 bytes, and to meet the length requirement of the encrypted AID field, a padding field (i.e., B in FIG. 9) with a length of 14 bytes is utilized. Accordingly, a receiver determines the length of the encrypted contents field based on the encryption method and/or the ciphertext length in the encryption information, such that the padding field may be ignored.

Subsequently, the AP uses a second included AID (e.g., 2038, 2039, or 2047, or any value of 2008-2044) to indicate that a subsequent Per AID TID Info field is the Per AID TID Original Info field, wherein the Per AID TID Original Info field includes the block Ack starting sequence control field and the block Ack bitmap field in the original Per AID TID Info field.

The STA with the capability of protecting a BA frame, upon identifying that the protected AID in the Per AID TID Encrypted Info field is consistent with its own AID, reads an AID TID Info field in a next Per AID TID Info field, determines, in the case that the AID TID Info field is found to carry a second AID value, that the Per AID TID Info field is the Per AID TID Original Info field, and then reads information in the Per AID TID Original Info field.

Upon reading an AID TID Info field in a Per AID TID Original Info field, the Legacy-STA without the capability of protecting a BA frame finds that a second AID value carried in the AID TID Info field cannot correspond to the valid AID within the range of 1 to 2007, and then ignores subsequent corresponding information (i.e., information in the block Ack bitmap field) based on the length indicated in the block Ack starting sequence control field.

In some embodiments, the first AID value is the same as or different from the second AID value. In the case that the first AID value is different from the second AID value, the STA receiving the multi-STA BA frame identifies a Per AID TID Encrypted Info field and a Per AID TID Original Info field accordingly. In the case that the first AID value is the same as the second AID value, the STA receiving the multi-STA BA frame, when identifying a first Per AID TID Info field carrying a reserved AID value, thinks that the Per AID TID Info field is the Per AID TID Encrypted Info field, and determines whether a next Per AID TID Info field carrying the same reserved AID value is the Per AID TID Original Info field based on first indication information (e.g., Origin BA Info indication bit information) in the Per AID TID Encrypted Info field. For example, in the case that the Origin BA Info indicator bit is set to 1, the next Per AID TID Info field carrying the same reserved AID value is the Per AID TID Original Info field; and in the case that the Origin BA Info indicator bit is set to 0, the next Per AID TID Info field carrying the same reserved AID value is not the Per AID TID Original Info field, but is a Per AID TID Encrypted Info field corresponding to other STA. Alternatively, in the case that the Origin BA Info indicator bit is set to 0, the next Per AID TID Info field carrying the same reserved AID value is the Per AID TID Original Info field; and in the case that the Origin BA Info indicator bit is set to 1, the next Per AID TID Info field carrying the same reserved AID value is not the Per AID TID Original Info field, but is a Per AID TID Encrypted Info field corresponding to another STA. The STA, when determining that the next Per AID TID Info field carrying the same reserved AID value is a Per AID TID Original Info field, extracts information in the Per AID TID Original Info field and performs subsequent processing.

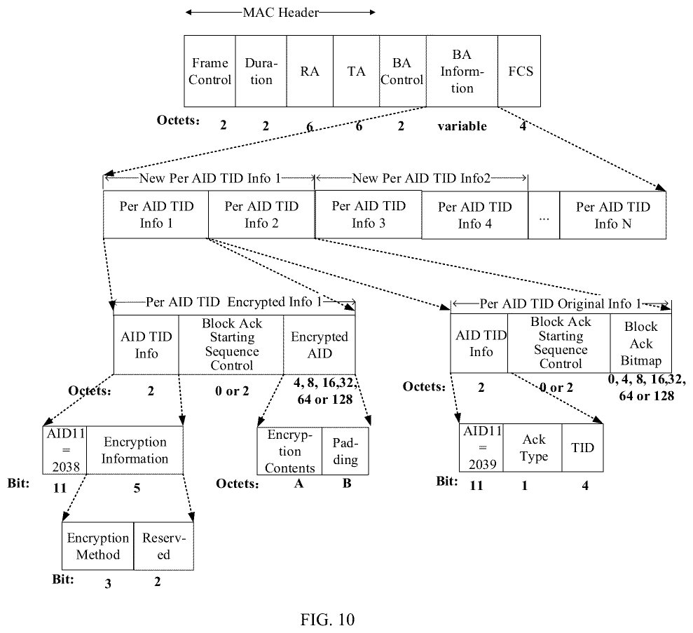

FIG. 10 is a schematic diagram of another frame format of a protected multi-STA BA frame according to the present disclosure. A value of an AID11 field in the Per AID TID Encrypted Info field in FIG. 10 is 2038, and is configured to identify that the AID11 field belongs to the Per AID TID Encrypted Info field, that is, the subsequent encryption information field carries an encryption method and the encrypted AID field carries a protected AID (e.g., an AID ciphertext). A value of an AID11 field in the Per AID TID Original Info field in FIG. 10 is 2039 (different from the value of the AID11 field in the aforementioned Per AID TID Encrypted Info field), and is configured to identify that the AID11 field belongs to the Per AID TID Original Info field, that is, the subsequent block Ack starting sequence control field and the block Ack bitmap field carry information in the block Ack starting sequence control and the block Ack bitmap in the original Per AID TID field.

Unlike the embodiment shown in FIG. 9, in the embodiment shown in FIG. 10, the encryption information field is included in the AID TID Info field (the encryption information field in FIG. 9 is included in the Per AID TID Original Info field), occupying positions of an Ack type field and a TID field originally present in the AID TID Info field. Therefore, in the embodiment shown in FIG. 10, a new Per AID TID Info field necessarily includes a Per AID TID Original Info field, wherein the Per AID TID Original Info field includes the Ack type field and the TID field. As the new Per AID TID Info field necessarily includes the Per AID TID Original Info field, the Origin BA Info indication field does not need to be included in the encryption information field.

Other fields in the frame format shown in FIG. 10 are the same as the corresponding fields in FIG. 9, and the receiving processing mechanism is also the same as the receiving mechanism in the example of FIG. 9, which are not repeated herein.

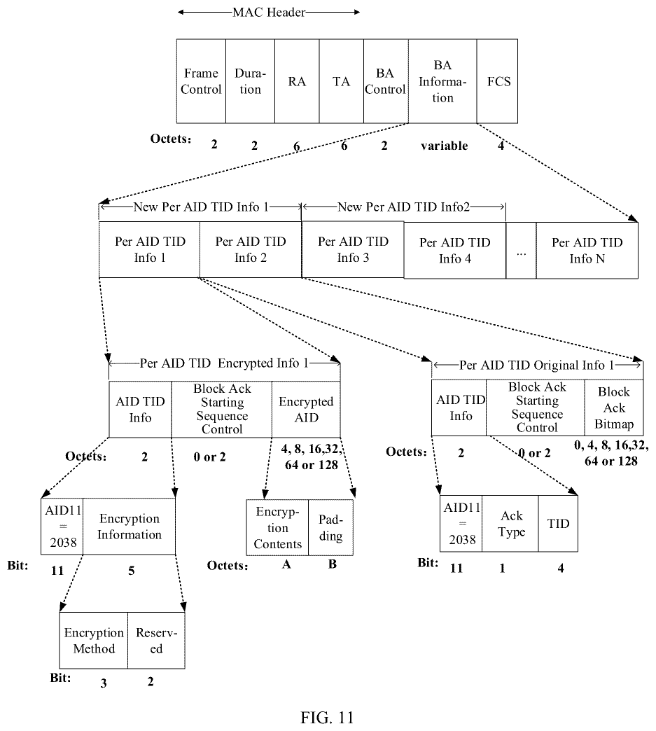

FIG. 11 is a schematic diagram of another frame format of a protected multi-STA BA frame according to the present disclosure. In FIG. 11, the value of the AID11 field in the Per AID TID Encrypted Info field is 2038 (or 2047 or any value of 2008-2044), and is configured to identify that the AID11 field belongs to the Per AID TID Encrypted Info field, that is, the subsequent encryption information field carries the encryption method and the encrypted AID field carries the protected AID (e.g., the AID ciphertext). The value of the AID11 field in the Per AID TID Original Info field in FIG. 11 is 2038 (or 2047 or any value of 2008-2044, which is the same as the value of the AID11 field in the Per AID TID Encrypted Info field).

Similar to the embodiment shown in FIG. 10, in the embodiment shown in FIG. 11, the encryption information field is included in the AID TID Info field, and occupies the positions of the Ack type field and the TID field originally present in the AID TID Info field, such that the new Per AID TID Info field necessarily includes the Per AID TID Original Info field, wherein the Per AID TID Original Info field includes the Ack type field and the TID field. As the new Per AID TID Info field necessarily includes the Per AID TID Original Info field, the Origin BA Info indication field does not need to be included in the encryption information field.

Other fields in the frame format shown in FIG. 11 are the same as the corresponding fields in FIG. 9, and are not repeated herein.

Upon receiving a protected multi-STA BA frame, the receiving end considers that the Per AID TID Info field is the Per AID TID Encrypted Info field in the case that the value of the AID11 field in a certain Per AID TID Info field in the BA information is identified as the reserved AID value (e.g., 2038 described above); and considers that the Per AID TID Info field is the Per AID TID Original Info field in the case that the value of the AID11 field in the next Per AID TID Info field in the Per AID TID Encrypted Info field is the same (e.g., 2038 described above). The Per AID TID Encrypted Info field and the Per AID TID Original Info field form a new Per AID TID Info field, wherein the new Per AID TID Info field correspond to one STA. Other contents in the receiving processing mechanism are the same as those in the example of FIG. 9, and are not repeated herein.

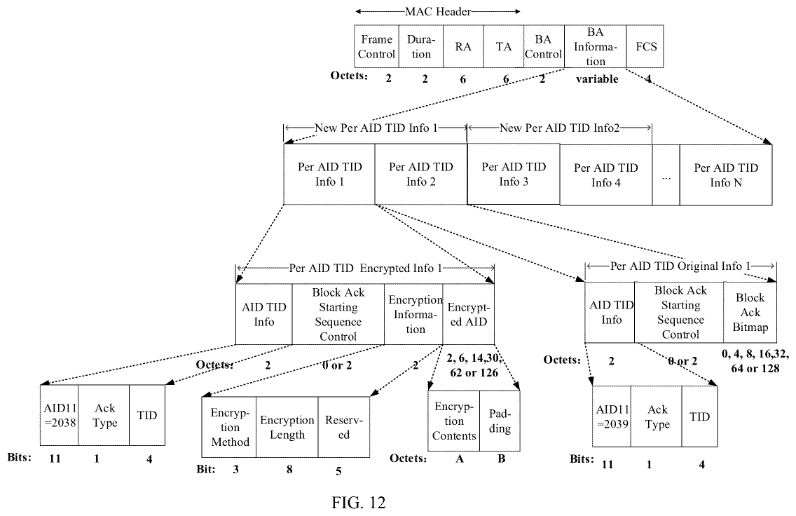

FIG. 12 is a schematic diagram of another frame format of a protected multi-STA BA frame according to the present disclosure. The value of the AID11 field in the Per AID TID Encrypted Info field in FIG. 12 is 2038 (or 2047 or any value of 2008-2044), and is configured to identify that the AID11 field belongs to the Per AID TID Encrypted Info field, which indicates that the subsequent encryption information carries the encryption method and/or the encryption length and the encrypted AID field carries the AID ciphertext.

The value of the AID11 field in the Per AID TID Original Info field is made to be 2039 (or 2047 or any value of 2008-2044, which is different from the value of the AID11 field in the aforementioned Per AID TID Encrypted Info field), and is configured to identify that the AID11 field belongs to the Per AID TID Original Info field. This indicates that the subsequent block Ack starting sequence control field and the block Ack bitmap field are information in the block Ack starting sequence control and the block Ack bitmap in the original Per AID TID field.

In the example of FIG. 12, the encryption information field includes an encryption method field, an encryption length field and a reserved field, wherein lengths of the three fields are 3 bits, 8 bits and 5 bits, respectively; and the encryption method field is configured to carry the encryption algorithm or the information digest algorithm information, and the encryption length field is configured to carry the length of the protected AID.

The receiving processing mechanism in this embodiment is also the same as the receiving mechanism in the example in FIG. 9, and is not repeated herein.

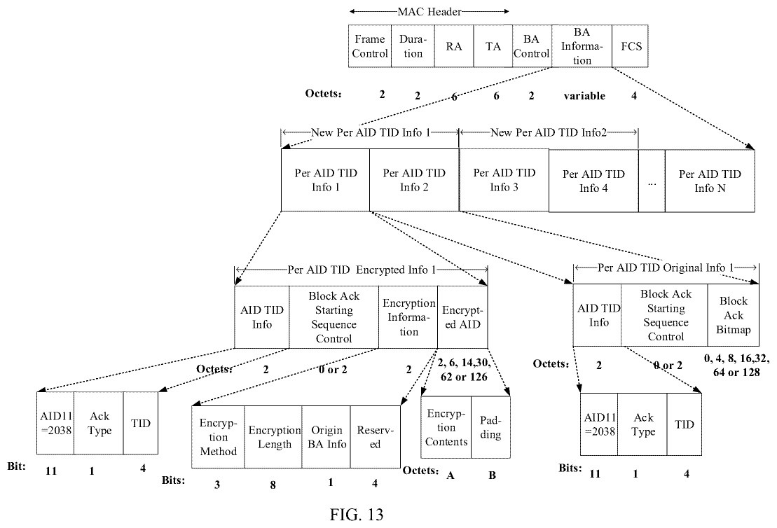

FIG. 13 is a schematic diagram of another frame format of a protected multi-STA BA frame according to the present disclosure. The value of the AID11 field in the Per AID TID Encrypted Info field in FIG. 13 is 2038 (or 2039 or 2047 or any value of 2008-2044), and is configured to identify that the AID11 field belongs to the Per AID TID Encrypted Info field, that is, the subsequent encryption information field carries the encryption method and the encrypted AID field carries the protected AID (e.g., the AID ciphertext). The value of the AID11 field in the Per AID TID Original Info field in FIG. 12 is 2038 (or 2039 or 2047 or any value of 2008-2044, which is the same as the value of the AID11 field in the Per AID TID Encrypted Info field).

The example shown in FIG. 13 is similar to the example shown in FIG. 12, but the difference is that as the value of the AID11 field in the Per AID TID Original Info field is the same as the value of the AID11 field in the Per AID TID Encrypted Info field, to identify whether the field behind the Per AID TID Encrypted Info field is the Per AID TID Original Info field, an Origin BA Info indicator bit is added to the Per AID TID Encrypted Info field. As shown in FIG. 13, the encryption information field includes an encryption method field and/or an encryption length field, and further includes an Origin BA Info field, wherein the Origin BA Info field is configured to carry an Origin BA Info indicator bit. The encrypted AID field carries the protected AID (e.g., the AID ciphertext). For example, in the case that the Origin BA Info indicator bit is set to 0, the next Per AID TID Info field carrying the same reserved AID value is the Per AID TID Original Info field; and in the case that the Origin BA Info indicator bit is set to 1, the next Per AID TID Info field carrying the same reserved AID value is not the Per AID TID Original Info field, but is a Per AID TID Encrypted Info field corresponding to other STA. Alternatively, in the case that the Origin BA Info indicator bit is set to 1, the next Per AID TID Info field carrying the same reserved AID value is the Per AID TID Original Info field; and in the case that the Origin BA Info indicator bit is set to 0, the next Per AID TID Info field carrying the same reserved AID value is not the Per AID TID Original Info field, but is a Per AID TID Encrypted Info field corresponding to another STA.

Other fields in the frame format shown in FIG. 13 are the same as the corresponding fields in FIG. 12, and the receiving processing mechanism is also the same as the receiving mechanism in the example of FIG. 9, which are not repeated herein.

The frame structures of various protected multi-STA BA frames are introduced above. In the protected multi-STA BA frame, the AID may be protected by using encryption or the information digest algorithm, and the STA receiving the protected multi-STA BA frame may identify whether the AID in the frame is consistent with its own AID.

For example, after the first STA receives the BA frame, the method further includes: extracting by the first STA, in the case that the Per AID TID Info field in the BA frame carries the first AID value, the first information and the protected privacy-related information from the Per AID TID Info field (e.g., the above Per AID TID Encrypted Info field) carrying the first AID value; and

identifying, by the first STA, the protected privacy-related information based on the first information.

The above protection method may include encrypting the AID, or computing the AID by using the information digest algorithm, or computing the AID and other information by using the information digest algorithm, or computing the AID ciphertext by using the information digest algorithm, or computing the AID ciphertext and other information by using the information digest algorithm, or protecting the AID by using two or more of the aforementioned methods. Accordingly, the STA receiving the BA frame may decrypt the AID ciphertext or compute the AID ciphertext by using the same information digest algorithm to determine whether the received AID is consistent with its own AID.

For example, identifying, by the first STA, the protected privacy-related information based on the first information includes:
acquiring a plaintext of the privacy-related information by decrypting, by the first STA, the protected privacy-related information using the encryption algorithm information in the first information;
comparing, by the first STA, the plaintext of the privacy-related information with privacy-related information of the first STA, and determining the Per AID TID Info field carrying the first AID value as the first Per AID TID Info field corresponding to the first STA in the case that the plaintext is consistent with the privacy-related information;
and/or, processing, by the first STA, the privacy-related information of the first STA by using the encryption algorithm information and/or the message digest algorithm information in the first information, comparing a processed result with the protected privacy-related information, and determining the Per AID TID Info field carrying the first AID value as the first Per AID TID Info field corresponding to the first STA in the case that the processed result is consistent with the protected privacy-related information.

Further, in the case that a next Per AID TID Info field of the first Per AID TID Info field corresponding to the first STA carries the second AID value, BA bitmap information is read from the next Per AID TID Info field. In this case, the first AID value and the second AID value may be different values, such that the STA can identify whether a Per AID TID Info field is a Per AID TID Encrypted Info field or a Per AID TID Original Info field based on the first AID value and the second AID value.

Alternatively, the embodiment of the present disclosure further includes: identifying a first indication information (e.g., the Origin BA Info indicator bit described above) in the first Per AID TID Info field corresponding to the first STA, and reading, in the case the first indication information indicates that a next Per AID TID Info field is the second Per AID TID Info field corresponding to the first STA, BA bitmap information from the second Per AID TID Info field corresponding to the first STA. In this case, the first AID value and the second AID value may be the same.

In the case that the AP protects the AID by performing information digest computation on the AID and other information, the STA, when receiving the BA frame, may compute its own AID and the aforementioned other information by using the same information digest algorithm to determine whether a computation result is consistent with the received result, and hence determines whether the protected AID is its own AID.

For example, the first STA extracts second information from a next Per AID TID Info field of the Per AID TID Info field (e.g., the Per AID TID Encrypted Info field described above) carrying the first AID value, wherein the second information may include at least one of a BA bitmap, an acknowledgement type, or a TID (e.g., information included in a Per AID TID Original Info field); and the first STA processes its own privacy-related information and the second information by using message digest algorithm information in the first information, compares a processed result with the protected privacy-related information, and determines the Per AID TID Info field carrying the first AID value as the first Per AID TID Info field (e.g., the Per AID TID Encrypted Info field described above) corresponding to the first STA in the case that the processed result is consistent with the protected privacy-related information.

As the AID and the information included in the Per AID TID Original Info field are computed by using the message digest algorithm, in the case that the AP transmits a protected multi-STA BA frame to the STA, the protected multi-STA BA frame contains a plurality of new Per AID TID Info fields, wherein each of the new Per AID TID Info fields needs to contain a Per AID TID Encrypted Info field and a Per AID TID Original Info field. As the Per AID TID Original Info field is necessarily included, the Per AID TID Encrypted Info field may not carry the Origin BA Info indicator bit described above.

For the Legacy-STA, as it does not have the protection capability, after the protected multi-STA BA frame is received, the information in the corresponding Per AID TID Info field indicated by the reserved AID value may be ignored.

For example, the embodiments of the present disclosure may further include: in the case that the Per AID TID Info field in the BA frame carries the first AID value or the second AID value, the first STA ignores the Per AID TID Info field carrying the first AID value or the second AID value.

That is, in the case that the Legacy-STA finds that a Per AID TID Info field in a received BA frame carries the first AID value, the Legacy-STA determines that the Per AID TID Info field is the Per AID TID Encrypted Info field described above; and in the case that the Legacy-STA finds that the Per AID TID Info field in the received BA frame carries the second AID value, the Legacy-STA determines that the Per AID TID Info field is the Per AID TID Original Info field described above. As the Legacy-STA does not have the protection support capability, the Legacy-STA cannot identify the AID in the Per AID TID Encrypted Info field, such that the information in the Per AID TID Encrypted Info field indicated by the first AID value is ignored, and the following Per AID TID Original Info field is ignored.

As some encryption algorithms have certain requirements on the length of the encrypted plaintext and the length of some fields in the BA frame, in the case that the AID is encrypted, the present disclosure may perform operations such as data padding to meet the requirements on the encryption length and the length of the fields.

Accordingly, acquiring the plaintext of the privacy-related information by decrypting, by the first STA, the protected privacy-related information using the encryption algorithm information in the first information includes: determining, by the first STA, a valid ciphertext in the protected privacy-related information based on the encryption algorithm information in the first information; acquiring plaintext information by decrypting the valid ciphertext; and acquiring the plaintext of the privacy-related information by extracting a valid plaintext from the plaintext information.

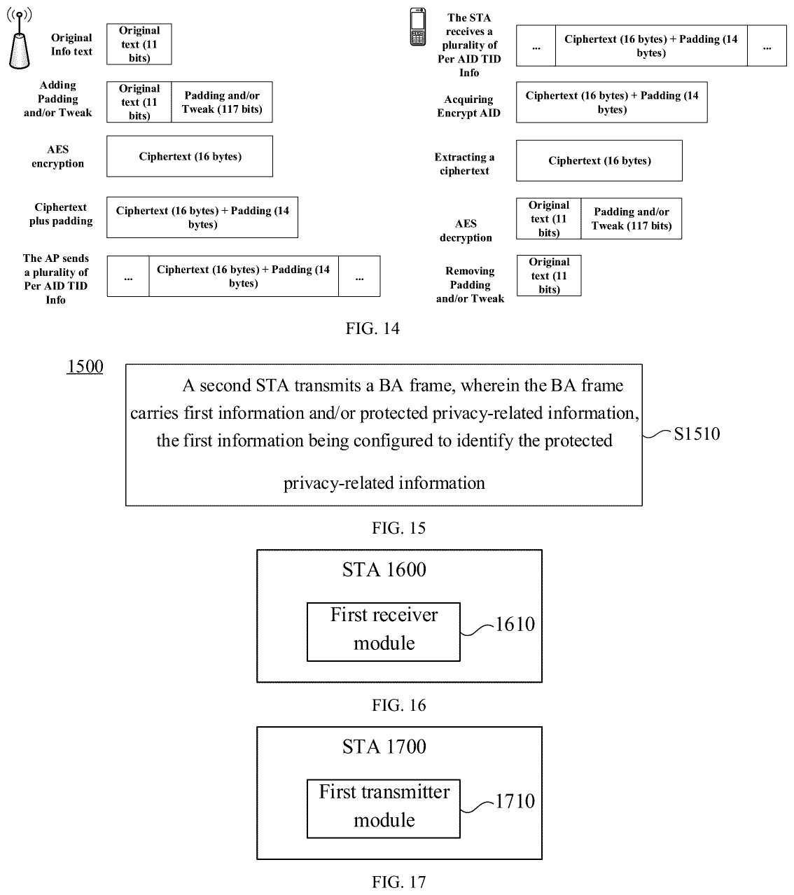

For example, in the case that the AP encrypts a multi-STA BA frame, it needs to consider the requirement of the encryption algorithm on the length of input data, and padding (padding data) or Tweak (random perturbation data, which may enhance the protection of the ciphertext) may be taken to pad the input data, and at the same time, the Legacy-STA compatibility needs to be considered, and the ciphertext may need to be padded as well. The STA, when decrypting, may acquire a ciphertext ending position through calculation based on an encryption method to ignore the corresponding padding and Tweak fields. FIG. 14 is a schematic diagram of implementation of encryption and decryption of a multi-STA BA frame according to the present disclosure.

FIG. 14 shows an example of adding padding and/or Tweak to a multi-STA BA frame by using the AES128 encryption algorithm; and for the AP, a length of an AID original field (11 bits) of the multi-STA BA frame is less than an integer multiple of 16 bytes, firstly, padding and/or random perturbation (Tweak) is added to the original text until the length is 16 bytes, and then the multi-STA BA frame is encrypted by using the AES128 encryption algorithm. To ensure the compatibility of the multi-STA BA frame with the Legacy-STA, padding is required to a length of 30 (possible length values of 2, 6, 14, 30, 62, or 126) bytes.

For the receiving STA, the processing processes are as follows:

(1) Determination of a length of a valid ciphertext field: as padding may be present in the received encrypted AID field, after the Block Ack Starting Sequence Control determines the total length of Encryption Info and Encrypted AID, a valid ciphertext length in the encrypted AID field also needs to be determined. For example, the encryption method is determined to be the AES128 algorithm by the encryption method in the encryption information field, then the encrypted ciphertext is determined to be 16 bytes in length, and the STA extracts the first 16 bytes of ciphertext information in the encrypted AID field, ignores the last 14 bytes of padding, and then acquires a decrypted plaintext by decrypting the ciphertext by using a key;

(2) Extraction of valid plaintext information: as the padding field or the Tweak field is added in the plaintext decrypted in the process (1), the STA needs to further extract valid plaintext information. For example, the extraction method is as follows: based on a type field or a subtype field in the MAC header, it can be determined that the frame is the multi-STA BA frame, such that it is determined that the encrypted data is the AID (11 bits in length), and in FIG. 14, as the padding field and the Tweak field are placed at the end, the first 11 bits of the decrypted plaintext may be extracted as a valid AID, and the last 117 bits are ignored.

In addition, FIG. 14 shows an example that the padding field and the Tweak field are placed behind the AID plaintext, the padding field and the Tweak field may also be placed in front of the AID plaintext or at other position, and the placement can be determined in the specific implementations, which is not limited in the present disclosure.

In the embodiments of the present disclosure, both of the protected privacy-related information and the first information configured to identify the protected privacy-related information are carried in the BA frame, such that the privacy-related information is protected in the transmission process, and hence the privacy protection is enhanced.

Another communication method is further provided in the present disclosure. The communication method is optionally applicable to the system shown in FIG. 1, but is not limited thereto. FIG. 15 is a flowchart of implementation of another communication method according to some embodiments of the present disclosure, wherein the method includes at least some of the following:

S1510, a second STA transmits a BA frame, wherein the BA frame carries first information and protected privacy-related information, the first information being configured to identify the protected privacy-related information.

In some embodiments, the BA frame includes a multi-STA BA frame.

In some embodiments, the privacy-related information includes AID information.

In some embodiments, the BA frame includes a BA information field; wherein the BA information field includes at least one first protection field; the first protection field including a first Per AID TID Info field; and the first Per AID TID Info field carrying the first information and the protected privacy-related information.

In some embodiments, the first information includes at least one of: encryption algorithm information and/or message digest algorithm information; a length of the protected privacy-related information; or first indication information, wherein the first indication information is configured to indicate whether the first protection field includes a second Per AID TID Info field.

In some embodiments, the second Per AID TID Info field carries at least one of a BA bitmap, an acknowledgement type (Ack type), or a TID.

In some embodiments, the first Per AID TID Info field includes a protection information field and a protected AID field; wherein the protection information field carries the encryption algorithm information and/or the message digest algorithm information; and the protected AID field carries the protected privacy-related information.

In some embodiments, the first Per AID TID Info field further includes a block acknowledgement starting sequence control field, wherein the block acknowledgement starting sequence control field is configured to indicate a sum of the length of the protection information field and the length of the protected AID field.

In some embodiments, the case that the first Per AID TID Info field includes the protection information field includes: the first Per AID TID Info field includes a first AID TID information field, wherein the first AID TID information field includes the protection information field.

In some embodiments, the first Per AID TID Info field further includes a block acknowledgement starting sequence control field, wherein the block acknowledgement starting sequence control field is configured to indicate a length of the protected AID field.

In some embodiments, the first Per AID TID Info field carries a first AID value, wherein the first AID value is configured to identify the first Per AID TID Info field.

In some embodiments, the second Per AID TID Info field carries a second AID value, wherein the second AID value is configured to identify the second Per AID TID Info field.

In some embodiments, the second AID value is the same as or different from the first AID value.

In some embodiments, the method further includes: receiving, by the second STA, protection capability information of the first STA for the BA frame.

In some embodiments, the protection capability information of the first STA for the BA frame is carried in an association request frame and/or an authentication frame received by the second STA.

In some embodiments, the association request frame and/or the authentication frame includes a first protection capability information field, wherein the first protection capability information field includes a first field indicating protection capability of the BA frame, wherein the first field indicating protection capability of the BA frame carries the protection capability information of the first STA for the BA frame.

In some embodiments, the first protection capability information field further includes at least one of a first field indicating protection capability of a trigger frame or a first field indicating protection capability of a NDPA; wherein the first field indicating protection capability of the trigger frame carries protection capability information of the first STA for the trigger frame; and the first field indicating protection capability of the NDPA carries protection capability information of the first STA for the NDPA.

In some embodiments, the first protection capability information field further includes a first element identifier field.

In some embodiments, the first element identifier field carries a reserved element identification.

In some embodiments, the first protection capability information field further includes a second element identifier field and a first element identification extension field.

In some embodiments, a value of the second element identifier field is 255; and the first element identification extension field carries a reserved element extension identification.

In some embodiments, the association request frame and/or the association authentication frame includes a first extended capability field, wherein the first extended capability field includes a second field indicating protection capability of a BA frame, wherein the second field indicating protection capability of the BA frame carries the protection capability information of the first STA for the BA frame.

In some embodiments, the first extended capability field further includes a third element identifier field.

In some embodiments, the first extended capability field further includes at least one of a second field indicating protection capability of a trigger frame or a second field indicating protection capability of a NDPA; wherein the second field indicating protection capability of the trigger frame carries protection capability information of the first STA for the trigger frame; and the second field indicating protection capability of the NDPA carries protection capability information of the first STA for the NDPA.

In some embodiments, the second field indicating protection capability of the BA frame, the second field indicating protection capability of the trigger frame or the second field indicating protection capability of the NDPA occupies a reserved bit of the first extended capability field.

In some embodiments, the method further includes: transmitting, by the second STA, protection capability information of the second STA for the BA frame.

In some embodiments, the protection capability information of the second STA for the BA frame is carried in an association response frame and/or an authentication frame transmitted by the second STA.

In some embodiments, the association response frame and/or the authentication frame includes a second protection capability information field, wherein the second protection capability information field includes a third field indicating protection capability of a BA frame, wherein the third field indicating protection capability of the BA frame carries the protection capability information of the second STA for the BA frame.

In some embodiments, the second protection capability information field further includes at least one of a third field indicating protection capability of a trigger frame or a third field indicating protection capability of a NDPA; wherein the third field indicating protection capability of the trigger frame carries protection capability information of the second STA for the trigger frame; and the third field indicating protection capability of the NDPA carries protection capability information of the second STA for the NDPA.

In some embodiments, the second protection capability information field further includes a fourth element identifier field.

In some embodiments, the fourth element identifier field carries a second element identification value, wherein the second element identification value is configured to identify the second protection capability information field.

In some embodiments, the second protection capability information field further includes a fifth element identifier field and a second element identification extension field.

In some embodiments, a value of the fifth element identifier field is 255; and the second element identification extension field carries a second element extension identification value, wherein the second element extension identification value is configured to identify the second protection capability information field.

In some embodiments, the association response frame and/or the authentication frame includes a second extended capability field, wherein the second extended capability field includes a fourth field indicating protection capability of a BA frame, wherein the fourth field indicating protection capability of the BA frame carries the protection capability information of the second STA for the BA frame.

In some embodiments, the second extended capability field further includes a sixth element identifier field.

In some embodiments, the second extended capability field further includes at least one of a fourth field indicating protection capability of a trigger frame or a fourth field indicating protection capability of a NDPA; wherein the fourth field indicating protection capability of the trigger frame carries protection capability information of the second STA for the trigger frame; and the fourth field indicating protection capability of the NDPA carries protection capability information of the second STA for the NDPA.

In some embodiments, the fourth field indicating protection capability of the BA frame, the fourth field indicating protection capability of the trigger frame or the fourth field indicating protection capability of the NDPA occupies a second position of the second extended capability field.

In some embodiments, the second STA includes an access point (AP).

In some embodiments, the method further includes: generating a key by performing, by the second STA, key agreement with the first STA.

In the embodiments of the present disclosure, both of the protected privacy-related information and the first information configured to identify the protected privacy-related information are carried in the BA frame, such that the privacy-related information is protected in the transmission process, and hence the privacy protection is enhanced.

The embodiments of the present disclosure further provide an STA, and FIG. 16 is a schematic structural diagram of an STA according to some embodiments of the present disclosure, wherein the STA includes: a first receiver module 1610, configured to receive a BA frame, wherein the BA frame carries first information and protected privacy-related information, the first information being configured to identify the protected privacy-related information.

In some embodiments, the BA frame includes a multi-STA BA frame.

In some embodiments, the privacy-related information includes an association identifier (AID).

In some embodiments, the BA frame includes a BA information field; wherein the BA information field includes at least one first protection field; the first protection field includes a first per association identifier traffic identifier information (Per AID TID Info) field; and the first Per AID TID Info field carries first information and protected privacy-related information.

In some embodiments, the first information includes at least one of: encryption algorithm information and/or message digest algorithm information; a length of the protected privacy-related information; or first indication information, wherein the first indication information is configured to indicate whether the first protection field includes a second Per AID TID Info field.

In some embodiments, the second Per AID TID Info field carries at least one of a BA bitmap, an acknowledgement type (Ack type), or a TID.

In some embodiments, the first Per AID TID Info field includes a protection information field and a protected AID field; wherein the protection information field carries the encryption algorithm information and/or the message digest algorithm information; and the protected AID field carries the protected privacy-related information.

In some embodiments, the first Per AID TID Info field further includes a block acknowledgement starting sequence control field, wherein the block acknowledgement starting sequence control field is configured to indicate a sum of the length of the protection information field and the length of the protected AID field.

In some embodiments, the case that the first Per AID TID Info field includes the protection information field includes: the first Per AID TID Info field includes a first AID TID information field, wherein the first AID TID information field includes the protection information field.

In some embodiments, the first Per AID TID Info field further includes a block acknowledgement starting sequence control field, wherein the block acknowledgement starting sequence control field is configured to indicate a length of the protected AID field.

In some embodiments, the first Per AID TID Info field carries a first AID value, wherein the first AID value is configured to identify the first Per AID TID Info field.

In some embodiments, the second Per AID TID Info field carries a second AID value, wherein the second AID value is configured to identify the second Per AID TID Info field.

In some embodiments, the second AID value is the same as or different from the first AID value.

In some embodiments, the STA further includes: a first identifying module, configured to extract, in the case that the Per AID TID Info field in the BA frame carries the first AID value, the first information and the protected privacy-related information from the Per AID TID Info field carrying the first AID value; and identify the protected privacy-related information based on the first information.

In some embodiments, the first identifying module 1610 is configured to:

acquire a plaintext of the privacy-related information by decrypting the protected privacy-related information using the encryption algorithm information in the first information; and

compare the plaintext of the privacy-related information with privacy-related information of the first STA, and determine the Per AID TID Info field carrying the first AID value as the first Per AID TID Info field corresponding to the first STA in the case that the plaintext is consistent with the privacy-related information.

In some embodiments, the first identifying module 1610 is configured to:

process the privacy-related information of the first STA by using the encryption algorithm information and/or the message digest algorithm information in the first information, compare a processed result with the protected privacy-related information, and determine the Per AID TID Info field carrying the first AID value as the first Per AID TID Info field corresponding to the first STA in the case that the processed result is consistent with the protected privacy-related information.

In some embodiments, the STA further includes: a first reading module, configured to read BA bitmap information from a next Per AID TID Info field in the case that the next Per AID TID Info field of the first Per AID TID Info field corresponding to the first STA carries the second AID value.

In some embodiments, the STA further includes: a second reading module, configured to identify the first indication information in the first Per AID TID Info field corresponding to the first STA, and read BA bitmap information from the second Per AID TID Info field corresponding to the first STA in the case that the first indication information indicates that a next Per AID TID Info field is the second Per AID TID Info field corresponding to the first STA.

In some embodiments, the first identifying module 1610 is configured to: extract second information from a next Per AID TID Info field of the Per AID TID Info field carrying the first AID value, wherein the second information includes at least one of a BA bitmap, an acknowledgement type, or a TID; and process the privacy-related information of the first STA and the second information by using the message digest algorithm information in the first information, compare a processed result with the protected privacy-related information, and determine the Per AID TID Info field carrying the first AID value as the first Per AID TID Info field corresponding to the first STA in the case that the processed result is consistent with the protected privacy-related information.

In some embodiments, the STA further includes: a third reading module, configured to read BA bitmap information from the next Per AID TID Info field.

In some embodiments, the first identifying module is configured to: determine a valid ciphertext in the protected privacy-related information based on the encryption algorithm information in the first information; acquire plaintext information by decrypting the valid ciphertext; and acquire the plaintext of the privacy-related information by extracting a valid plaintext from the plaintext information.

In some embodiments, the STA further includes: a second identifying module, configured to ignore, in the case that the Per AID TID Info field in the BA frame carries the first AID value or the second AID value, the Per AID TID Info field carrying the first AID value or the second AID value.

In some embodiments, the STA further includes: a first capability announcement module, configured to transmit protection capability information of the first STA for the BA frame.

In some embodiments, the protection capability information of the first STA for the BA frame is carried in an association request frame and/or an authentication frame transmitted by the first STA.

In some embodiments, the association request frame and/or the authentication frame includes a first protection capability information field, wherein the first protection capability information field includes a first field indicating protection capability of the BA frame, wherein the first filed indicating protection capability of the BA frame carries the protection capability information of the first STA for the BA frame.

In some embodiments, the first protection capability information field further includes at least one of a first field indicating protection capability of a trigger frame or a first field indicating protection capability of a null data packet announcement (NDPA); wherein the first field indicating protection capability of the trigger frame carries protection capability information of the first STA for the trigger frame; and the first field indicating protection capability of the NDPA carries protection capability information of the first STA for the NDPA.

In some embodiments, the first protection capability information field further includes a first element identifier field.

In some embodiments, the first element identifier field carries a first element identification value, wherein the first element identification value is configured to identify the first protection capability information field.

In some embodiments, the first protection capability information field further includes a second element identifier field and a first element identification extension field.

In some embodiments, a value of the second element identifier field is 255; and the first element identification extension field carries a first element extension identification value, wherein the first element extension identification value is configured to identify the first protection capability information field.

In some embodiments, the association request frame and/or the association authentication frame includes a first extended capability field, wherein the first extended capability field includes a second field indicating protection capability of a BA frame, wherein the second field indicating protection capability of the BA frame carries the protection capability information of the first STA for the BA frame.

In some embodiments, the first extended capability field further includes a third element identifier field.

In some embodiments, the first extended capability field further includes at least one of a second field indicating protection capability of a trigger frame or a second field indicating protection capability of a NDPA; wherein the second field indicating protection capability of the trigger frame carries protection capability information of the first STA for the trigger frame; and the second field indicating protection capability of the NDPA carries protection capability information of the first STA for the NDPA.

In some embodiments, the second field indicating protection capability of the BA frame, the second field indicating protection capability of the trigger frame or the second field indicating protection capability of the NDPA occupies a first position of the first extended capability field.

In some embodiments, the STA further includes: a second receiver module, configured to receive protection capability information of a second STA for the BA frame.

In some embodiments, the protection capability information of the second STA for the BA frame is carried in an association response frame and/or an authentication frame received by the first STA.

In some embodiments, the association response frame and/or the authentication frame includes a second protection capability information field, wherein the second protection capability information field includes a third field indicating protection capability of a BA frame, wherein the third field indicating protection capability of the BA frame carries the protection capability information of the second STA for the BA frame.

In some embodiments, the second protection capability information field further includes at least one of a third field indicating protection capability of a trigger frame or a third field indicating protection capability of a NDPA; wherein the third field indicating protection capability of the trigger frame carries protection capability information of the second STA for the trigger frame; and the third field indicating protection capability of the NDPA carries protection capability information of the second STA for the NDPA.

In some embodiments, the second protection capability information field further includes a fourth element identifier field.

In some embodiments, the fourth element identifier field carries a second element identification value, wherein the second element identification value is configured to identify the second protection capability information field.

In some embodiments, the second protection capability information field further includes a fifth element identifier field and a second element identification extension field.

In some embodiments, a value of the fifth element identifier field is 255; and the second element identification extension field carries a second element extension identification value, wherein the second element extension identification value is configured to identify the second protection capability information field.

In some embodiments, the association response frame and/or the authentication frame includes a second extended capability field, wherein the second extended capability field includes a fourth field indicating protection capability of a BA frame, wherein the fourth field indicating protection capability of the BA frame carries the protection capability information of the second STA for the BA frame.

In some embodiments, the second extended capability field further includes a sixth element identifier field.

In some embodiments, the second extended capability field further includes at least one of a fourth field indicating protection capability of a trigger frame or a fourth field indicating protection capability of a NDPA; wherein the fourth field indicating protection capability of the trigger frame carries protection capability information of the second STA for the trigger frame; and the fourth field indicating protection capability of the NDPA carries protection capability information of the second STA for the NDPA.

In some embodiments, the fourth field indicating protection capability of the BA frame, the fourth field indicating protection capability of the trigger frame or the fourth field indicating protection capability of the NDPA occupies a second position of the second extended capability field.

In some embodiments, the second STA includes an access point (AP).

In some embodiments, the STA further includes: a first key agreement module, configured to generate a key by performing key agreement with the second STA.

It is understandable that the above and other operations and/or functions of the modules in the STA based on the embodiments of the present disclosure are respectively for performing the corresponding processes of the first STA in the method 200 of FIG. 2, and are not repeated herein for brevity.

An STA is further provided in the embodiments of the present disclosure. FIG. 17 is a schematic structural diagram of another STA according to some embodiments of the present disclosure, wherein the STA includes: a first transmitter module 1710, configured to transmit a BA frame, wherein the BA frame carries first information and protected privacy-related information, the first information being configured to identify the protected privacy-related information.

In some embodiments, the BA frame includes a multi-STA BA frame.

In some embodiments, the privacy-related information includes association identifier (AID) information.

In some embodiments, the BA frame includes a BA information field; wherein the BA information field includes at least one first protection field; the first protection field including a first Per AID TID Info field; and the first Per AID TID Info field carrying first information and protected privacy-related information.

In some embodiments, the first information includes at least one of: encryption algorithm information and/or message digest algorithm information; a length of the protected privacy-related information; or first indication information, wherein the first indication information is configured to indicate whether the first protection field includes a second Per AID TID Info field.

In some embodiments, the second Per AID TID Info field carries at least one of a BA bitmap, an acknowledgement type (Ack type), or a TID.

In some embodiments, the first Per AID TID Info field includes a protection information field and a protected AID field; wherein the protection information field carries the encryption algorithm information and/or the message digest algorithm information; and the protected AID field carries the protected privacy-related information.

In some embodiments, the first Per AID TID Info field further includes a block acknowledgement starting sequence control field, wherein the block acknowledgement starting sequence control field is configured to indicate a sum of the length of the protection information field and the length of the protected AID field.

In some embodiments, the case that the first Per AID TID Info field includes the protection information field includes: the first Per AID TID Info field includes a first AID TID information field, wherein the first AID TID information field includes the protection information field.

In some embodiments, the first Per AID TID Info field further includes a block acknowledgement starting sequence control field, wherein the block acknowledgement starting sequence control field is configured to indicate a length of the protected AID field.

In some embodiments, the first Per AID TID Info field carries a first AID value, wherein the first AID value is configured to identify the first Per AID TID Info field.

In some embodiments, the second Per AID TID Info field carries a second AID value, wherein the second AID value is configured to identify the second Per AID TID Info field.

In some embodiments, the second AID value is the same as or different from the first AID value.

In some embodiments, the STA further includes: a third receiver module, configured to receive protection capability information of the first STA for the BA frame.

In some embodiments, the protection capability information of the first STA for the BA frame is carried in an association request frame and/or an authentication frame received by the third receiver module.

In some embodiments, the association request frame and/or the authentication frame includes a first protection capability information field, wherein the first protection capability information field includes a first field indicating protection capability of the BA frame, wherein the first field indicating protection capability of the BA frame carries the protection capability information of the first STA for the BA frame.

In some embodiments, the first protection capability information field further includes at least one of a first field indicating protection capability of a trigger frame or a first field indicating protection capability of a null data packet announcement (NDPA); wherein the first field indicating protection capability of the trigger frame carries protection capability information of the first STA for the trigger frame; and

the first field indicating protection capability of the NDPA carries protection capability information of the first STA for the NDPA.

In some embodiments, the first protection capability information field further includes a first element identifier field.

In some embodiments, the first element identifier field carries a first element identification value, wherein the first element identification value is configured to identify the first protection capability information field.

In some embodiments, the first protection capability information field further includes a second element identifier field and a first element identification extension field.

In some embodiments, a value of the second element identifier field is 255; and the first element identification extension field carries a first element extension identification value, wherein the first element extension identification value is configured to identify the first protection capability information field.

In some embodiments, the association request frame and/or the association authentication frame includes a first extended capability field, wherein the first extended capability field includes a second field indicating protection capability of a BA frame, wherein the second field indicating protection capability of the BA frame carries the protection capability information of the first STA for the BA frame.

In some embodiments, the first extended capability field further includes a third element identifier field.

In some embodiments, the first extended capability field further includes at least one of a second field indicating protection capability of a trigger frame or a second field indicating protection capability of a NDPA; wherein the second field indicating protection capability of the trigger frame carries protection capability information of the first STA for the trigger frame; and the second field indicating protection capability of the NDPA carries protection capability information of the first STA for the NDPA.

In some embodiments, the second field indicating protection capability of the BA frame, the second field indicating protection capability of the trigger frame or the second field indicating protection capability of the NDPA occupies a first position of the first extended capability field.

In some embodiments, the STA further includes: a second capability announcement module, configured to transmit protection capability information of the STA for the BA frame.

In some embodiments, the protection capability information of the STA for the BA frame is carried in an association response frame and/or an authentication frame transmitted by the second capability announcement module.

In some embodiments, the association response frame and/or the authentication frame includes a second protection capability information field, wherein the second protection capability information field includes a third field indicating protection capability of a BA frame, wherein the third field indicating protection capability of the BA frame carries the protection capability information of the STA for the BA frame.

In some embodiments, the second protection capability information field further includes at least one of a third field indicating protection capability of a trigger frame or a third field indicating protection capability of a NDPA; wherein the third field indicating protection capability of the trigger frame carries protection capability information of the STA for the trigger frame; and the third field indicating protection capability of the NDPA carries protection capability information of the STA for the NDPA.

In some embodiments, the second protection capability information field further includes a fourth element identifier field.

In some embodiments, the fourth element identifier field carries a second element identification value, wherein the second element identification value is configured to identify the second protection capability information field.

In some embodiments, the second protection capability information field further includes a fifth element identifier field and a second element identification extension field.

In some embodiments, a value of the fifth element identifier field is 255; and the second element identification extension field carries a second element extension identification value, wherein the second element extension identification value is configured to identify the second protection capability information field.

In some embodiments, the association response frame and/or the authentication frame includes a second extended capability field, wherein the second extended capability field includes a fourth field indicating protection capability of a BA frame, wherein the fourth field indicating protection capability of the BA frame carries the protection capability information of the STA for the BA frame.

In some embodiments, the second extended capability field further includes a sixth element identifier field.

In some embodiments, the second extended capability field further includes at least one of a fourth field indicating protection capability of a trigger frame or a fourth field indicating protection capability of a NDPA; wherein the fourth field indicating protection capability of the trigger frame carries protection capability information of the STA for the trigger frame; and the fourth field indicating protection capability of the NDPA carries protection capability information of the STA for the NDPA.

In some embodiments, the fourth field indicating protection capability of the BA frame, the fourth field indicating protection capability of the trigger frame or the fourth field indicating protection capability of the NDPA occupies a second position of the second extended capability field.

In some embodiments, the STA includes an access point (AP).

In some embodiments, the STA further includes: a second key agreement module, configured to generate a key by performing key agreement with the first STA.

It is understandable that the above and other operations and/or functions of the modules in the terminal device based on the embodiments of the present disclosure are respectively for performing the corresponding processes of the second STA in the method 1500 in FIG. 15, and are not repeated herein for brevity.

It should be noted that the functions described for various modules (submodules, units, or components, or the like) in the STA 1600 and the STA 1700 according to the embodiments of the present disclosure can be implemented by different modules (submodules, units, or components, or the like) or by the same module (submodule, unit, or component, or the like). For example, the first transmitter module and the second transmitter module can be different modules, or the same module, and both can perform their corresponding functions in the embodiments of the present disclosure. In addition, the transmitter module and the receiver module in the embodiments of the present disclosure can be implemented by a transceiver of a device, and part or all of the remaining modules can be implemented by a processor of the device.

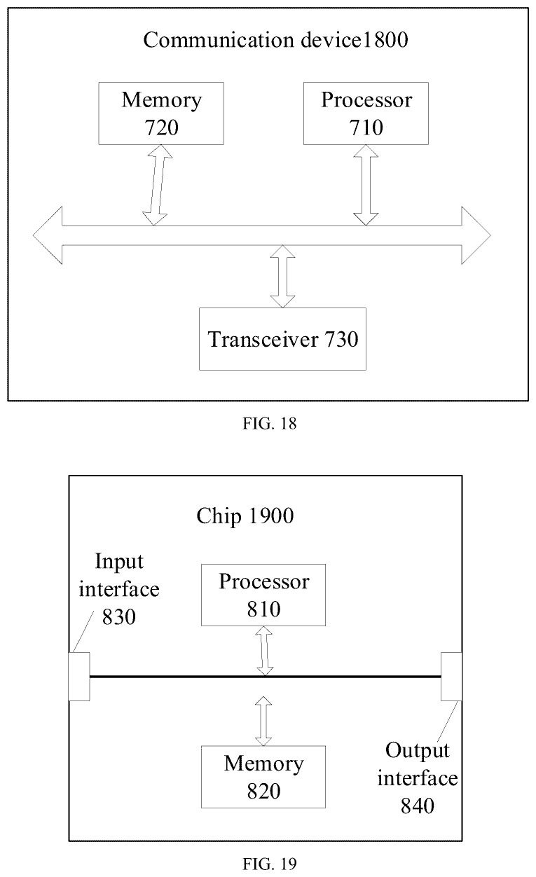

FIG. 18 is a schematic structural diagram of a communication device 1800 according to some embodiments of the present disclosure. The communication device 1800 shown in FIG. 18 includes a processor 710. The processor 710, when loading and running a computer program from a memory, is caused to perform the methods in embodiments of the present disclosure.

In some embodiments, as shown in FIG. 18, the communication device 1800 further includes the memory 720. The processor 710, when loading and running a computer program from the memory 720, is caused to perform the methods in the embodiments of the present disclosure.

The memory 720 is a separate device independent from the processor 710 or integrated in the processor 710.

In some embodiments, as shown in FIG. 18, the communication device 1800 further includes a transceiver 730. The processor 710 controls the transceiver 730 to communicate with other devices. For example, the processor 710 controls the transceiver 730 to transmit information or data to other devices, or to receive information or data from other devices.

The transceiver 730 includes a transmitter and a receiver. The transceiver 730 further includes one or more antennas.

In some embodiments, the communication device 1800 serves as the STA in the embodiments of the present disclosure. Additionally, the communication device 1800 performs the corresponding processes performed by the STA in various methods of the embodiments of the present disclosure. For brevity, details are not repeated herein.

FIG. 19 is a schematic structural diagram of a chip 1900 according to some embodiments of the present disclosure. The chip 1900 shown in FIG. 19 includes a processor 810. The processor 810, when loading and running a computer program from a memory, is caused to perform the methods in the embodiments of the present disclosure.

In some embodiments, as shown in FIG. 19, the chip 1900 further includes a memory 820. The processor 810, when loading and running a computer program from the memory 820, is caused to perform the methods in the embodiments of the present disclosure.

The memory 820 is a separate device independent from the processor 810, or the memory 802 is integrated in the processor 810.

In some embodiments, the chip 1900 further includes an input interface 830. The processor 810 controls the input interface 830 to communicate with other devices or chips. For example, the processor 810 controls the input interface 830 to acquire information or data from other devices or chips.

In some embodiments, the chip 1900 further includes an output interface 840. The processor 810 controls the output interface 840 to communicate with other devices or chips. For example, the processor 810 controls the output interface 840 to output information or data to other devices or chips.

In some embodiments, the chip is applicable to the STA in the embodiments of the present disclosure. Additionally, the chip performs the corresponding processes performed by the STA in various methods of the embodiments of the present disclosure. For brevity, details are not repeated herein.

It is understandable that the chip mentioned in the embodiments of the present disclosure is also referred to as a system-on-chip, a system chip, a chip system, or an on-chip system, or the like.

The aforementioned processor is a general-purpose processor, a digital signal processor (DSP), a field-programmable gate array (FPGA), an application-specific integrated circuit (ASIC), or another programmable logic device, a transistor logic device, a discrete hardware component, or the like. The aforementioned general-purpose processor is a microprocessor or any conventional processor, or the like.

The aforementioned memory is a volatile memory or a non-volatile memory, or may include both the volatile memory and the non-volatile memory. The non-volatile memory is a read-only memory (ROM), a programmable ROM (PROM), an erasable PROM (EPROM), an electrically EPROM (EEPROM), or a flash memory. The volatile memory is a random access memory (RAM).

It is understandable that the above-mentioned memories are exemplary but not limiting. For example, the memory in the embodiments of the present disclosure is a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a direct rambus RAM (DR RAM), and the like. That is, the memory in the embodiments of the present disclosure is intended to include, but is not limited to, these and any other suitable types of memories.

The above embodiments are fully or partially performed through software, hardware, firmware or any combination thereof. In the case of performed with software, it is fully or partially performed in the form of a computer program product. The computer program product includes one or more computer instructions. The computer program instructions, when loaded and run on a computer, generate, fully or partially, the processes or functions according to the embodiments of the present disclosure. The computer is a general-purpose computer, a specialized computer, a computer network or any other programmable apparatus. The computer instructions are stored in a computer-readable storage medium or transmitted from a computer-readable storage medium to another computer-readable storage medium. For example, the computer instructions are transmitted from one website, computer, server or data center to another website, computer, server or data center via wired (e.g., coaxial cable, fiber optic, digital subscriber line (DSL)) or wireless (e.g., infrared, wireless, microwave) means. The computer-readable storage medium is any available medium accessible by a computer, or may be a data storage device, such as a server or a data center, that includes one or more integrated available media. The available medium is a magnetic medium, such as a floppy disk, a hard disk or a magnetic tape, an optical medium, such as a DVD, or a semiconductor medium, such as a solid-state disk (SSD), or the like.

It is understandable that in the various embodiments of the present disclosure, a numerical order of the above-mentioned processes does not imply the sequence of execution. The execution order of these processes is determined by their functions and internal logic, and do not impose any limitation on the implementation of the embodiments of the present disclosure.

Those skilled in the art clearly understand that, for the convenience and brevity in description, specific working processes of the systems, apparatuses and units described above refer to the corresponding processes in the aforementioned method embodiments, which are not repeated herein.

The above descriptions are only specific embodiments of the present disclosure, but the protection scope of the present disclosure is not limited to these. Any person skilled in the art may easily think of a change or a substitution within the technical scope disclosed herein, and the change or the substitution shall fall within the protection scope of the present disclosure. Therefore, the protection scope of the present disclosure is subject to protection scope of claims.

1. A communication method, comprising:
receiving, by a first station (STA), a block acknowledgement (BA) frame, wherein the BA frame carries first information and/or protected privacy-related information, the first information being configured to identify the protected privacy-related information.

2. The method according to claim 1, wherein the BA frame comprises a multiple station (multi-STA) BA frame; and
wherein the privacy-related information comprises an association identifier (AID).

3. The method according to claim 1, wherein the BA frame comprises a BA information field, wherein:
the BA information field comprises at least one first protection field;
the first protection field comprising a first per association identifier traffic identifier information (Per AID TID Info) field; and
the first Per AID TID Info field carrying the first information and/or the protected privacy-related information, wherein the protected privacy-related information is carried in a protected AID field carries comprised in the first Per AID TID Info field, and the first information comprises at least one of:
encryption algorithm information and/or message digest algorithm information, the encryption algorithm information and/or the message digest algorithm information being carried in a protection information field comprised in the first Per AID TID Info field;
a length of the protected privacy-related information; or
first indication information, wherein the first indication information is configured to indicate whether the first protection field comprises a second Per AID TID Info field, the second Per AID TID Info field carrying at least one of a BA bitmap, an acknowledgement type (Ack type), or a TID.

4. The method according to claim 3, wherein the first Per AID TID Info field carries a first AID value, the first AID value being configured to identify the first Per AID TID Info field; and
wherein the second Per AID TID Info field carries a second AID value, the second AID value being configured to identify the second Per AID TID Info field and being the same as or different from the first AID value.

5. The method according to claim 1, further comprising:
extracting by the first STA, the first information and the protected privacy-related information from the Per AID TID Info field carrying the first AID value in a case that the Per AID TID Info field in the BA frame carries the first AID value; and
processing, by the first STA, privacy-related information of the first STA by using the encryption algorithm information and/or the message digest algorithm information in the first information, comparing a processed result with the protected privacy-related information, and determining the Per AID TID Info field carrying the first AID value as the first Per AID TID Info field corresponding to the first STA in a case that the processed result is consistent with the protected privacy-related information.

6. The method according to claim 1, further comprising:
transmitting, by the first STA, protection capability information of the first STA for the BA frame, wherein the protection capability information of the first STA for the BA frame is carried in an association request frame and/or an authentication frame transmitted by the first STA.

7. The method according to claim 6, wherein the association request frame and/or the authentication frame comprises a first protection capability information field, wherein the first protection capability information field comprises a first field indicating protection capability of a BA frame and at least one of a first field indicating protection capability of a trigger frame or a first field indicating protection capability of a null data packet announcement (NDPA), wherein:
the first field indicating protection capability of the BA frame carries the protection capability information of the first STA for the BA frame,
the first field indicating protection capability of the trigger frame carries protection capability information of the first STA for the trigger frame, and
the first field indicating protection capability of the NDPA carries protection capability information of the first STA for the NDPA; or
the association request frame and/or the association authentication frame comprises a first extended capability field, wherein the first extended capability field comprises a second field indicating protection capability of a BA frame and at least one of a first field indicating protection capability of a trigger frame or a first field indicating protection capability of a null data packet announcement (NDPA), wherein:
the second field indicating protection capability of the BA frame carries the protection capability information of the first STA for the BA frame,
the second field indicating protection capability of the trigger frame carries protection capability information of the first STA for the trigger frame, and
the second field indicating protection capability of the NDPA carries protection capability information of the first STA for the NDPA.

8. A communication device, comprising:
a processor and a memory, wherein the memory is configured to store a computer program, which when executed by the processor, causes the communication device to:
receive a block acknowledgement (BA) frame, wherein the BA frame carries first information and/or protected privacy-related information, the first information being configured to identify the protected privacy-related information.

9. The communication device according to claim 8, wherein the BA frame comprises a multiple station (multi-STA) BA frame; and
wherein the privacy-related information comprises an association identifier (AID).

10. The communication device according to claim 8, wherein the BA frame comprises a BA information field; wherein:
the BA information field comprises at least one first protection field;
the first protection field comprising a first per association identifier traffic identifier information (Per AID TID Info) field; and
the first Per AID TID Info field carrying the first information and/or the protected privacy-related information, wherein the protected privacy-related information is carried in a protected AID field carries comprised in the first Per AID TID Info field, and the first information comprises at least one of:
encryption algorithm information and/or message digest algorithm information, the encryption algorithm information and/or the message digest algorithm information being carried in a protection information field comprised in the first Per AID TID Info field;
a length of the protected privacy-related information; or
first indication information, wherein the first indication information is configured to indicate whether the first protection field comprises a second Per AID TID Info field, the second Per AID TID Info field carrying at least one of a BA bitmap, an acknowledgement type (Ack type), or a TID.

11. The communication device according to claim 10, wherein the first Per AID TID Info field carries a first AID value, the first AID value being configured to identify the first Per AID TID Info field; and
wherein the second Per AID TID Info field carries a second AID value, the second AID value being configured to identify the second Per AID TID Info field and being the same as or different from the first AID value.

12. The communication device according to claim 8, wherein the computer program, which when executed by the processor, further causes the communication device to:
extract the first information and the protected privacy-related information from the Per AID TID Info field carrying the first AID value in a case that the Per AID TID Info field in the BA frame carries the first AID value; and
process privacy-related information of the communication device by using the encryption algorithm information and/or the message digest algorithm information in the first information, comparing a processed result with the protected privacy-related information, and determining the Per AID TID Info field carrying the first AID value as the first Per AID TID Info field corresponding to the communication device in a case that the processed result is consistent with the protected privacy-related information.

13. The communication device according to claim 8, wherein the computer program, which when executed by the processor, further causes the communication device to:
transmit protection capability information of the communication device for the BA frame, wherein the protection capability information of the communication device for the BA frame is carried in an association request frame and/or an authentication frame transmitted by the communication device.

14. The communication device according to claim 13, wherein the association request frame and/or the authentication frame comprises a first protection capability information field, wherein the first protection capability information field comprises a first field indicating protection capability of a BA frame and at least one of a first field indicating protection capability of a trigger frame or a first field indicating protection capability of a null data packet announcement (NDPA), wherein:
the first field indicating protection capability of the BA frame carries the protection capability information of the first STA for the BA frame,
the first field indicating protection capability of the trigger frame carries protection capability information of the first STA for the trigger frame, and
the first field indicating protection capability of the NDPA carries protection capability information of the first STA for the NDPA; or
the association request frame and/or the association authentication frame comprises a first extended capability field, wherein the first extended capability field comprises a second field indicating protection capability of a BA frame and at least one of a first field indicating protection capability of a trigger frame or a first field indicating protection capability of a null data packet announcement (NDPA), wherein:
the second field indicating protection capability of the BA frame carries the protection capability information of the first STA for the BA frame,
the second field indicating protection capability of the trigger frame carries protection capability information of the first STA for the trigger frame, and
the second field indicating protection capability of the NDPA carries protection capability information of the first STA for the NDPA.

15. A communication device, comprising:
a processor and a memory, wherein the memory is configured to store a computer program, which when executed by the processor, causes the communication device to:
transmit a block acknowledgement (BA) frame, wherein the BA frame carries first information and/or protected privacy-related information, the first information being configured to identify the protected privacy-related information.

16. The communication device according to claim 15, wherein the BA frame comprises a multiple station (multi-STA) BA frame; and
wherein the privacy-related information comprises association identifier (AID) information.

17. The communication device according to claim 15, wherein the BA frame comprises a BA information field; wherein:
the BA information field comprises at least one first protection field;
the first protection field comprising a first per association identifier traffic identifier information (Per AID TID Info) field; and
the first Per AID TID Info field carrying the first information and/or the protected privacy-related information, wherein the protected privacy-related information is carried in a protected AID field carries comprised in the first Per AID TID Info field, and the first information comprises at least one of:
encryption algorithm information and/or message digest algorithm information, the encryption algorithm information and/or the message digest algorithm information being carried in a protection information field comprised in the first Per AID TID Info field;
a length of the protected privacy-related information; or
first indication information, wherein the first indication information is configured to indicate whether the first protection field comprises a second Per AID TID Info field, the second Per AID TID Info field carrying at least one of a BA bitmap, an acknowledgement type (Ack type), or a TID.

18. The communication device according to claim 17, wherein the first Per AID TID Info field carries a first AID value, the first AID value being configured to identify the first Per AID TID Info field; and
wherein the second Per AID TID Info field carries a second AID value, the second AID value being configured to identify the second Per AID TID Info field and being the same as or different from the first AID value.

19. The communication device according to claim 15, wherein the computer program, which when executed by the processor, further causes the communication device to:
receive protection capability information of a first STA for the BA frame, wherein the protection capability information of the first STA for the BA frame is carried in an association request frame and/or an authentication frame received by the communication device.

20. The communication device according to claim 19, wherein the association request frame and/or the authentication frame comprises a first protection capability information field, wherein the first protection capability information field comprises a first field indicating protection capability of a BA frame, the first field indicating protection capability of the BA frame carrying the protection capability information of the first STA for the BA frame; or
wherein the association request frame and/or the association authentication frame comprises a first extended capability field, wherein the first extended capability field comprises a second field indicating protection capability of a BA frame, the second field indicating protection capability of the BA frame carrying the protection capability information of the first STA for the BA frame.
